(19) United States
(12) Patent Application Publication
(10) Pub. No.: US 2012/0051732 A1
(43) Pub. Date: Mar. 1, 2012

(54) CAMERA BODY, IMAGING DEVICE, METHOD FOR CONTROLLING CAMERA BODY, PROGRAM, AND STORAGE MEDIUM STORING PROGRAM

(75) Inventors: Taizo Aoki, Hyogo (JP); Wataru Okamoto, Osaka (JP); Yuki Ueda, Osaka (JP); Ken Ishida, Osaka (JP)

(73) Assignee: Panasonic Corporation, Osaka (JP)

(21) Appl. No.: 13/166,816

(22) Filed: Jun. 23, 2011

(30) Foreign Application Priority Data
Aug. 31, 2010 (JP) 2010-195169
Apr. 21, 2011 (JP) 2011-094602

(51) Int. Cl. G03B 13/02

(52) U.S. Cl. 396/374

(57) ABSTRACT

A camera body is provided that supports an interchangeable lens unit configured to form left-eye and right-eye optical images of a subject. The camera body includes a body mount, an image production section, and an image display section. The interchangeable lens unit is supported by the body mount. The image production section is configured to produce stereo image data based on the left-eye and right-eye optical images. The image display section is configured to display a captured image based on the stereo image data. The image display section is also configured to restrict the real-time display of a captured image based on the stereo image data until the interchangeable lens unit is coupled to the body mount.

### CROSS-REFERENCE TO RELATED APPLICATIONS

This application claims priority under 35 U.S.C. §119 to Japanese Patent Application No. 2010-195169, filed on Aug. 31, 2010 and Japanese Patent Application No. 2011-094602, filed on Apr. 21, 2011. The entire disclosure of Japanese Patent Application Nos. 2010-195169 and 2011-094602 are hereby incorporated herein by reference.

### BACKGROUND

1. Technical Field

The technology disclosed herein relates to an imaging device and a camera body to which an interchangeable lens unit can be mounted. The technology disclosed herein also relates to a method for controlling a camera body, a program, and a storage medium for storing the program.

2. Background Information

An example of a known imaging device is an interchangeable lens type of digital camera. An interchangeable lens digital camera comprises an interchangeable lens unit and a camera body. This camera body has an imaging element such as a charge coupled device (CCD) image sensor or a complementary metal oxide semiconductor (CMOS) image sensor. The imaging element converts an optical image formed by the interchangeable lens unit into an image signal. This allows image data about a subject to be acquired.

Development of so-called three-dimensional displays has been underway for some years now. This has been accompanied by the development of digital cameras that produce what is known as stereo image data (image data for three-dimensional display use, including a left-eye image and a right-eye image).

However, a three-dimensional imaging-use optical system (hereinafter also referred to as a three-dimensional optical system) has to be used to produce a stereo image having parallax.

In view of this, development has been underway into an interchangeable lens unit equipped with a three-dimensional optical system. A three-dimensional optical system has, for example, a left-eye optical system and a right-eye optical system. A left-eye optical image is formed by the left-eye optical system and a right-eye optical image is formed by the right-eye optical system on an imaging element. The left- and right-eye optical images are disposed next to each other on the left and right on the imaging element, and stereo image data is produced on the basis of these two optical images. Also, the display section gives a real-time display of the left- or right-eye image (as a representative image) on the basis of stereo image data, or displays the left-eye and right-eye images three-dimensionally in real time, for example.

However, with an interchangeable lens unit having a left-eye optical system and a right-eye optical system, in a state in which the interchangeable lens unit has not been completely mounted to the camera body, the interchangeable lens unit will deviate in the rotational direction from the completed mounting position with respect to the camera body, so the left-eye and right-eye optical images end up deviating from the specified positions on the imaging element. Therefore, in a state in which the interchangeable lens unit has not been completely mounted to the camera body, the real-time image displayed on the display section is disturbed.

### SUMMARY

One object of the technology disclosed herein is to mitigate disturbance of a display image caused by the mounting state of the interchangeable lens unit to the camera body.

In accordance with one aspect of the technology disclosed herein, a camera body is provided that supports an interchangeable lens unit configured to form left-eye and right-eye optical images of a subject. The camera body comprises a body mount, an image production section, and an image display section. The interchangeable lens unit is supported by the body mount. The image production section is configured to produce stereo image data based on the left-eye and right-eye optical images. The image display section is configured to display a captured image based on the stereo image data. The image display section is also configured to restrict the real-time display of a captured image based on the stereo image data until the interchangeable lens unit is coupled to the body mount.

In accordance with another aspect of the technology disclosed herein, a program is provided that is configured to cause a camera body to detect the mounting state of an interchangeable lens unit, which is configured to form left-eye and right-eye optical images of a subject, to a camera body and to restrict real-time display of a captured image based on stereo image data of the left-eye and right-eye optical images on a display section until the interchangeable lens unit is coupled to the camera body.

These and other objects, features, aspects and advantages of the technology disclosed herein will become apparent to those skilled in the art from the following detailed description, which, taken in conjunction with the annexed drawings, discloses embodiments of the present invention.

### BRIEF DESCRIPTION OF DRAWINGS

Referring now to the attached drawings which form a part of this original disclosure:

FIG. 1 is an oblique view of a digital camera 1 (first embodiment);

FIG. 2 is an oblique view of a camera body 100 (first embodiment);

FIG. 3 is a rear view of a camera body 100 (first embodiment);

FIG. 4 is a simplified block diagram of a digital camera 1 (first embodiment);

FIG. 5 is a simplified block diagram of an interchangeable lens unit 200 (first embodiment);

FIG. 6 is a simplified block diagram of a camera body 100 (first embodiment);

FIG. 7A is an example of the configuration of lens identification information F1, FIG. 7B is an example of the configuration of lens characteristic information F2, and FIG. 7C is an example of the configuration of lens state information F3;

FIG. 8A is a time chart for a camera body and an interchangeable lens unit when the camera body is not compatible with three-dimensional imaging, and FIG. 8B is a time chart for a camera body and an interchangeable lens unit when the camera body and interchangeable lens unit are compatible with three-dimensional imaging;

FIG. 9 is a diagram of an extraction region;

FIG. 10 is a diagram of various parameters;

FIG. 11 is a simplified diagram of the configuration around a body mount and a lens mount;

FIGS. 12A to 12D are diagrams of the mounting state of the interchangeable lens unit (state A);

FIG. 13 is a flowchart of when the power is on;

FIG. 14 is a flowchart of when the power is on;

FIG. 15 is a flowchart of during imaging; and

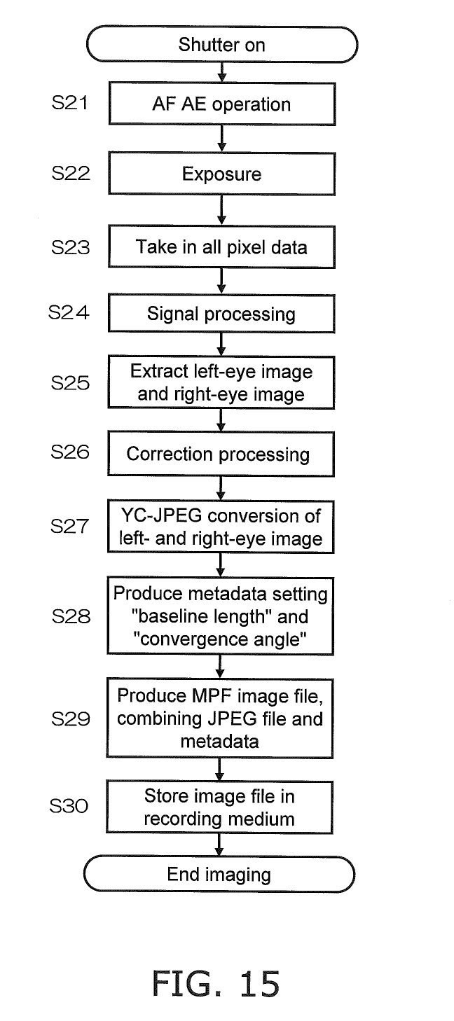

FIG. 16 is a flowchart of lens detection processing.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

Configuration of Digital Camera

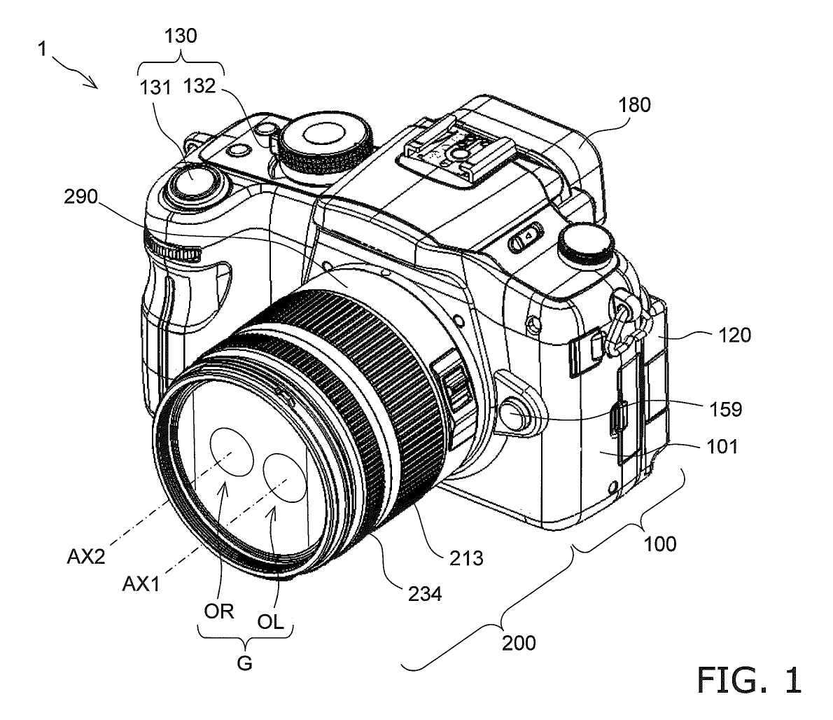

A digital camera 1 is an imaging device capable of three-dimensional imaging, and is an interchangeable lens type of digital camera. As shown in FIGS. 1 to 3, the digital camera 1 comprises an interchangeable lens unit 200 and a camera body 100 to which the interchangeable lens unit 200 can be mounted. The interchangeable lens unit 200 is a lens unit that is compatible with three-dimensional imaging, and forms optical images of a subject (a left-eye optical image and a right-eye optical image). The camera body 100 is compatible with both two- and three-dimensional imaging, and produces image data on the basis of the optical image formed by the interchangeable lens unit 200. In addition to the interchangeable lens unit 200 that is compatible with three-dimensional imaging, an interchangeable lens unit that is not compatible with three-dimensional imaging can also be attached to the camera body 100. That is, the camera body 100 is compatible with both two- and three-dimensional imaging.

For the sake of convenience in the following description, the subject side of the digital camera 1 will be referred to as “front,” the opposite side from the subject as “back” or “rear,” the vertical upper side in the normal orientation (landscape orientation) of the digital camera 1 as “upper,” and the vertical lower side as “lower.”

1: Interchangeable Lens Unit

The interchangeable lens unit 200 is a lens unit that is compatible with three-dimensional imaging. The interchangeable lens unit 200 in this embodiment makes use of a side-by-side imaging system with which two optical images are formed on a single imaging element by a pair of left and right optical systems.

As shown in FIGS. 1 to 4, the interchangeable lens unit 200 has a three-dimensional optical system a first drive unit 271, a second drive unit 272, a shake amount detecting sensor 275, and a lens controller 240. The interchangeable lens unit 200 further has a lens mount 250, a lens barrel 290, a zoom ring 213, and a focus ring 234. In the mounting of the interchangeable lens unit 200 to the camera body 100, the lens mount 250 is attached to a body mount 150 (discussed below) of the camera body 100. As shown in FIG. 1, the zoom ring 213 and the focus ring 234 are rotatably provided to the outer part of the lens barrel 290.

(1) Three-Dimensional Optical System G

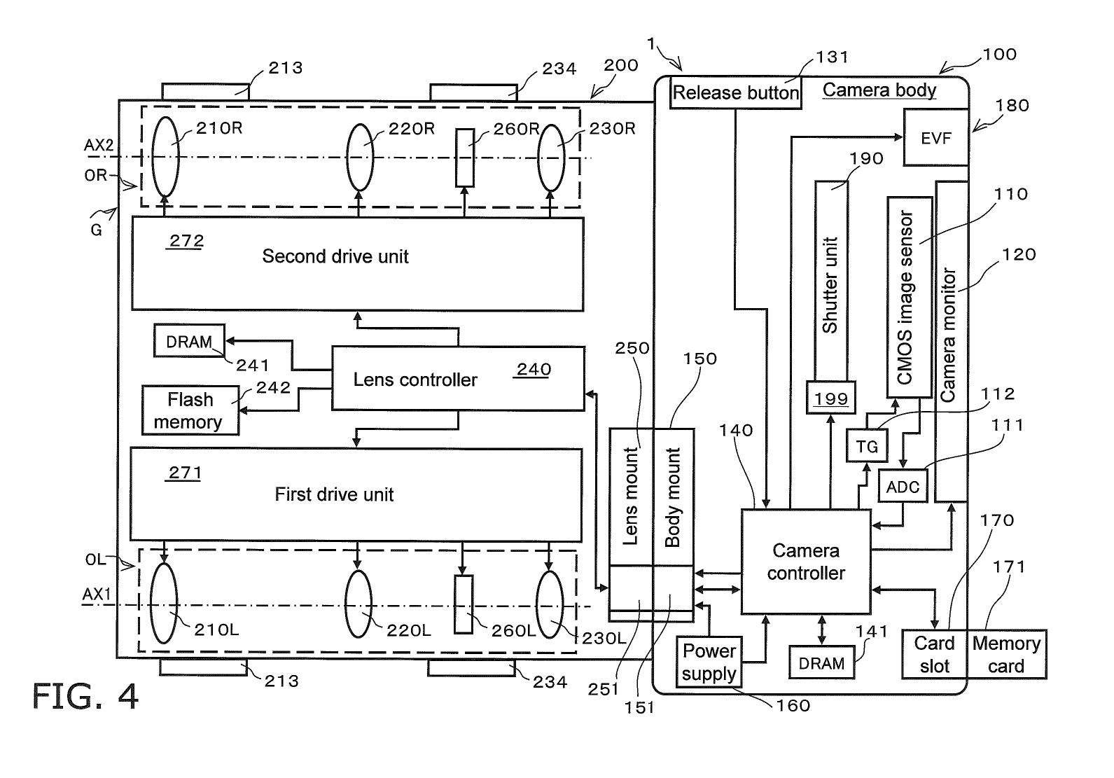

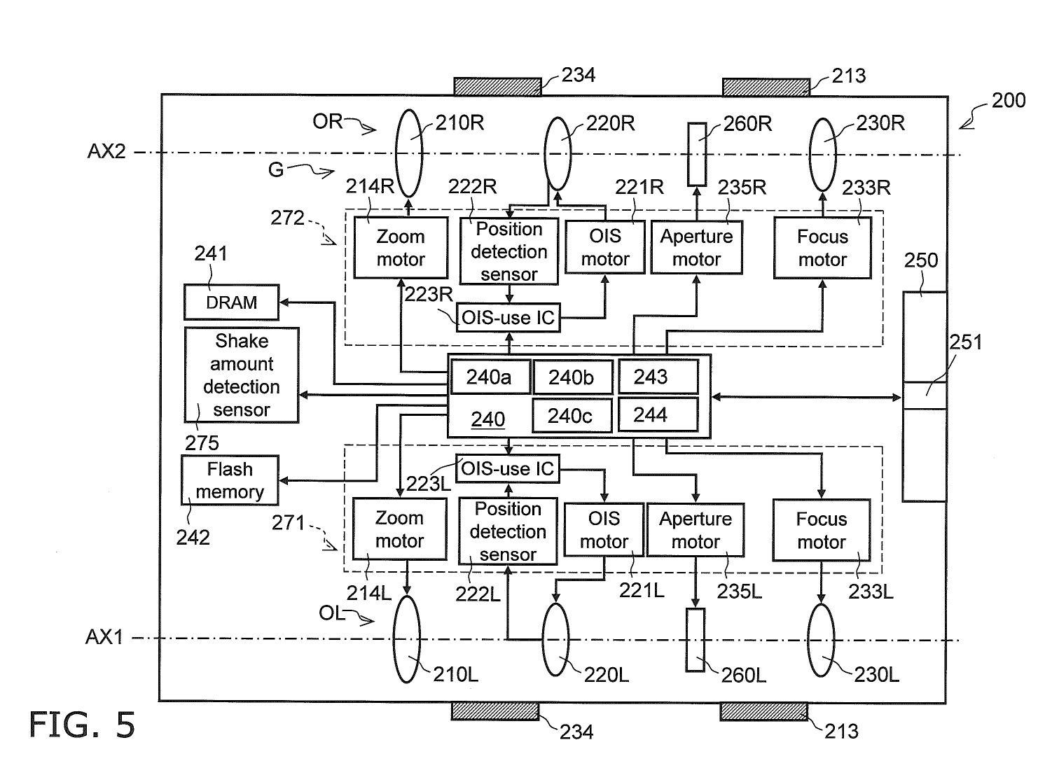

As shown in FIGS. 4 and 5, the three-dimensional optical system G is an optical system compatible with side-by-side imaging, and has a left-eye optical system OL and a right-eye optical system OR. The left-eye optical system OL and the right-eye optical system OR are disposed to the left and right of each other. Here, “left-eye optical system” refers to an optical system corresponding to a left-side perspective, and more specifically refers to an optical system in which the optical element disposed closest to the subject (the front side) is disposed on the left side facing the subject. Similarly, a “right-eye optical system” refers to an optical system corresponding to a right-side perspective, and more specifically refers to an optical system in which the optical element disposed closest to the subject (the front side) is disposed on the right side facing the subject.

The left-eye optical system OL is an optical system used to capture an image of a subject from a left-side perspective facing the subject, and includes a zoom lens 210L, an OIS lens 220L, an aperture unit 260L, and a focus lens 230L. The left-eye optical system OL has a first optical axis AX1, and is housed inside the lens barrel 290 in a state of being side by side with the right-eye optical system OR.

The zoom lens 210L is used to change the focal length of the left-eye optical system OL, and is disposed movably in a direction parallel with the first optical axis AX1. The zoom lens 210L is made up of one or more lenses. The zoom lens 210L is driven by a zoom motor 214L (discussed below) of the first drive unit 271. The focal length of the left-eye optical system OL can be adjusted by driving the zoom lens 210L in a direction parallel with the first optical axis AX1.

The OIS lens 220L is used to suppress displacement of the optical image formed by the left-eye optical system OL with respect to a CMOS image sensor 110 (discussed below). The OIS lens 220L is made up of one or more lenses. An OIS motor 221L drives the OIS lens 220L on the basis of a control signal sent from an OIS-use IC 223L so that the OIS lens 220L moves within a plane perpendicular to the first optical axis AX1. The OIS motor 221L can be, for example, a magnet (not shown) and a flat coil (not shown). The position of the OIS lens 220L is detected by a position detecting sensor 222L (discussed below) of the first drive unit 271.

An optical system is employed as the blur correction system in this embodiment, but the blur correction system may instead be an electronic system in which image data produced by the CMOS image sensor 110 is subjected to correction processing, or a sensor shift system in which an imaging element such as the CMOS image sensor 110 is driven within a plane that is perpendicular to the first optical axis AX1.

The aperture unit 260L adjusts the amount of light that passes through the left-eye optical system OL. The aperture unit 260L has a plurality of aperture vanes (not shown). The aperture vanes are driven by an aperture motor 235L (discussed below) of the first drive unit 271. A camera controller 140 (discussed below) controls the aperture motor 235L.

The focus lens 230L is used to adjust the subject distance (also called the object distance) of the left-eye optical system OL, and is disposed movably in a direction parallel to the first optical axis AX1. The focus lens 230L is driven by a focus motor 233L (discussed below) of the first drive unit 271. The focus lens 230L is made up of one or more lenses.

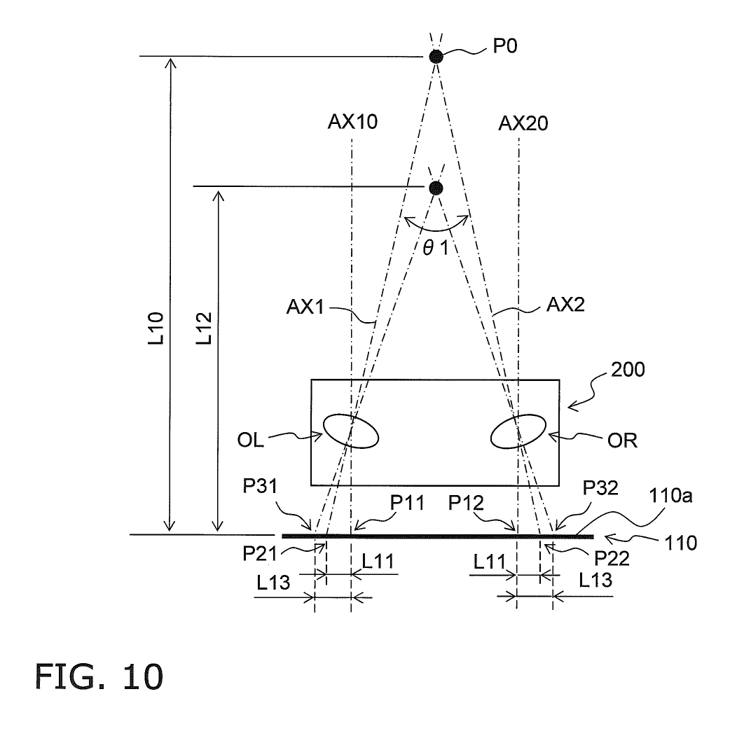

The right-eye optical system OR is an optical system used to capture an image of a subject from a right-side perspective facing the subject, and includes a zoom lens 210R, an OIS lens 220R, an aperture unit 260R, and a focus lens 230R. The right-eye optical system OR has a second optical axis AX2, and is housed inside the lens barrel 290 in a state of being side by side with the left-eye optical system OL. The spec of the right-eye optical system OR is the same as the spec of the left-eye optical system OL. The angle formed by the first optical axis AX1 and the second optical axis AX2 (angle of convergence) is referred to as the angle θ1 shown in FIG. 10.

The zoom lens 210R is used to change the focal length of the right-eye optical system OR, and is disposed movably in a direction parallel with the second optical axis AX2. The zoom lens 210R is made up of one or more lenses. The zoom lens 210R is driven by a zoom motor 214R (discussed below) of the second drive unit 272. The focal length of the right-eye optical system OR can be adjusted by driving the zoom lens 210R in a direction parallel with the second optical axis AX2. The drive of the zoom lens 2108 is synchronized with the drive of the zoom lens 210L. Therefore, the focal length of the right-eye optical system OR is the same as the focal length of the left-eye optical system OL.

The OIS lens 220R is used to suppress displacement of the optical image formed by the right-eye optical system OR with respect to the CMOS image sensor 110. The OIS lens 220R is made up of one or more lenses. An OIS motor 221R drives the OIS lens 220R on the basis of a control signal sent from an OIS-use IC 223R so that the OIS lens 220R moves within a plane perpendicular to the second optical axis AX2. The OIS motor 221R can be, for example, a magnet (not shown) and a flat coil (not shown). The position of the OIS lens 220R is detected by a position detecting sensor 222R (discussed below) of the second drive unit 272.

An optical system is employed as the blur correction system in this embodiment, but the blur correction system may instead be an electronic system in which image data produced by the CMOS image sensor 110 is subjected to correction processing, or a sensor shift system in which an imaging element such as the CMOS image sensor 110 is driven within a plane that is perpendicular to the second optical axis AX2.

The aperture unit 260R adjusts the amount of light that passes through the right-eye optical system OR. The aperture unit 260R has a plurality of aperture vanes (not shown). The aperture vanes are driven by an aperture motor 235R (discussed below) of the second drive unit 272. The camera controller 140 controls the aperture motor 235R. The drive of the aperture unit 260R is synchronized with the drive of the aperture unit 260L. Therefore, the aperture value of the right-eye optical system OR is the same as the aperture value of the left-eye optical system OL.

The focus lens 230R is used to adjust the subject distance (also called the object distance) of the right-eye optical system OR, and is disposed movably in a direction parallel to the second optical axis AX2. The focus lens 230R is driven by a focus motor 233R (discussed below) of the second drive unit 272. The focus lens 230R is made up of one or more lenses.

(2) First Drive Unit 271

The first drive unit 271 is provided to adjust the state of the left-eye optical system OL, and as shown in FIG. 5, has the zoom motor 214L, the OIS motor 221L, the position detecting sensor 222L, the OIS-use IC 223L, the aperture motor 235L, and the focus motor 233L.

The zoom motor 214L drives the zoom lens 210L. The zoom motor 214L is controlled by the lens controller 240.

The OIS motor 221L drives the OIS lens 220L. The position detecting sensor 222L is a sensor for detecting the position of the OIS lens 220L. The position detecting sensor 222L is a Hall element, for example, and is disposed near the magnet of the OIS motor 221L. The OIS-use IC 223L controls the OIS motor 221L on the basis of the detection result of the position detecting sensor 222L and the detection result of the shake amount detecting sensor 275. The OIS-use IC 223L acquires the detection result of the shake amount detecting sensor 275 from the lens controller 240. Also, the OIS-use IC 223L sends the lens controller 240 a signal indicating the position of the OIS lens 220L, at a specific period.

The aperture motor 235L drives the aperture unit 260L. The aperture motor 235L is controlled by the lens controller 240.

The focus motor 233L drives the focus lens 230L. The focus motor 233L is controlled by the lens controller 240. The lens controller 240 also controls the focus motor 233R, and synchronizes the focus motor 233L and the focus motor 233R. Consequently, the subject distance of the left-eye optical system OL is the same as the subject distance of the right-eye optical system OR. Examples of the focus motor 233L include a DC motor, a stepping motor, a servo motor, and an ultrasonic motor.

(3) Second Drive Unit 272

The second drive unit 272 is provided to adjust the state of the right-eye optical system OR, and as shown in FIG. 5, has the zoom motor 214R, the OIS motor 221R, the position detecting sensor 222R, the OIS-use IC 223R, the aperture motor 235R, and the focus motor 233R.

The zoom motor 214R drives the zoom lens 210R. The zoom motor 214R is controlled by the lens controller 240.

The OIS motor 221R drives the OIS lens 220R. The position detecting sensor 222R is a sensor for detecting the position of the OIS lens 220R. The position detecting sensor 222R is a Hall element, for example, and is disposed near the magnet of the OIS motor 221R. The OIS-use IC 223R controls the OIS motor 221R on the basis of the detection result of the position detecting sensor 222R and the detection result of the shake amount detecting sensor 275. The OIS-use IC 223R acquires the detection result of the shake amount detecting sensor 275 from the lens controller 240. Also, the OIS-use IC 223R sends the lens controller 240 a signal indicating the position of the OIS lens 220R, at a specific period.

The aperture motor 235R drives the aperture unit 260R. The aperture motor 235R is controlled by the lens controller 240.

The focus motor 233R drives the focus lens 230R. The focus motor 233R is controlled by the lens controller 240. The lens controller 240 synchronizes the focus motor 233L and the focus motor 233R. Consequently, the subject distance of the left-eye optical system OL is the same as the subject distance of the right-eye optical system OR. Examples of the focus motor 233R include a DC motor, a stepping motor, a servo motor, and an ultrasonic motor.

(4) Lens Controller 240

The lens controller 240 controls the various components of the interchangeable lens unit 200 (such as the first drive unit 271 and the second drive unit 272) on the basis of control signals sent from the camera controller 140. The lens controller 240 sends and receives signals to and from the camera controller 140 via the lens mount 250 and the body mount 150. During control, the lens controller 240 uses a DRAM 241 as a working memory.

The lens controller 240 has a CPU (central processing unit) 240a, a ROM (read only memory) 240b, and a RAM (random access memory) 240c, and can perform various functions by reading programs stored in the ROM 240b into the CPU 240a.

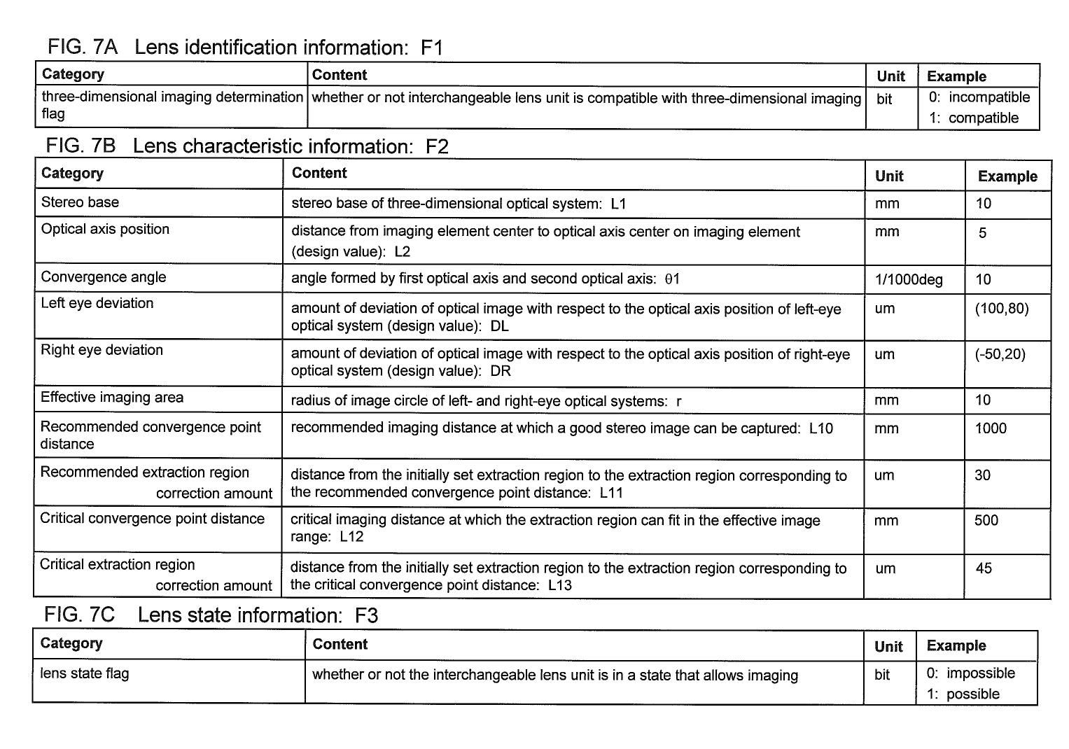

Also, a flash memory 242 (an example of a correction information storage section, and an example of an identification information storage section) stores parameters or programs used in control by the lens controller 240. For example, in the flash memory 242 are pre-stored lens identification information F1 (see FIG. 7A) indicating that the interchangeable lens unit 200 is compatible with three-dimensional imaging, and lens characteristic information F2 (see FIG. 7B) that includes flags and parameters indicating the characteristics of the three-dimensional optical system G Lens state information F3 (see FIG. 7C) indicating whether or not the interchangeable lens unit 200 is in a state that allows imaging is held in the RAM 240c, for example.

The lens identification information F1, lens characteristic information F2, and lens state information F3 will now be described.

Lens Identification Information F1

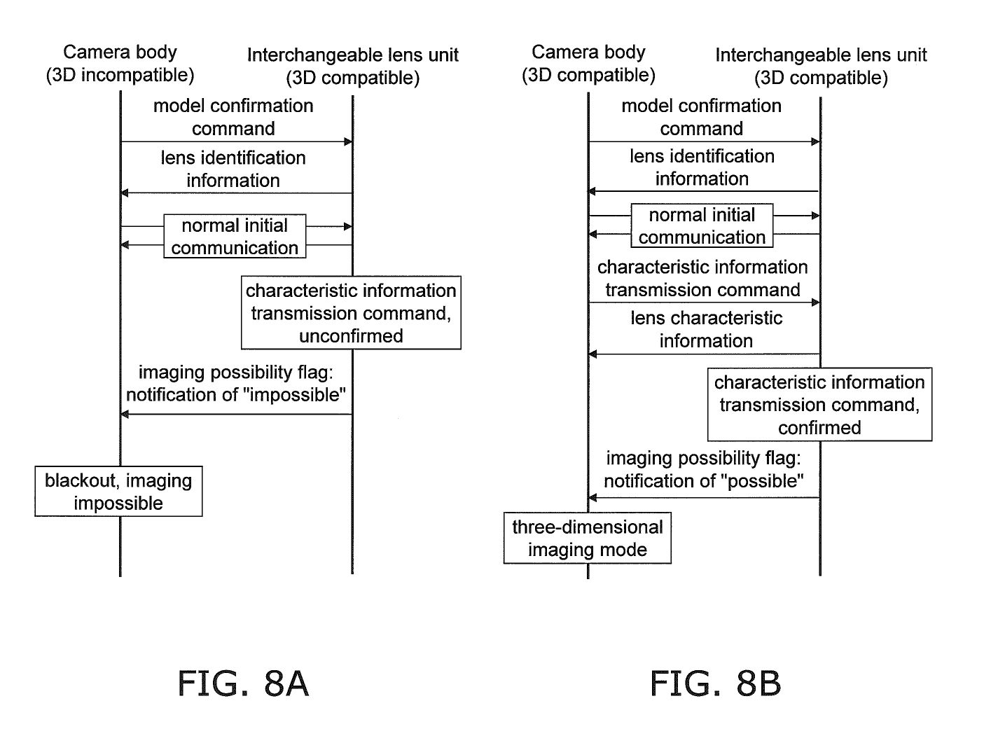

The lens identification information F1 is information indicating whether or not the interchangeable lens unit is compatible with three-dimensional imaging, and is stored ahead of time in the flash memory 242, for example. As shown in FIG. 7A, the lens identification information F1 is a three-dimensional imaging determination flag stored at a specific address in the flash memory 242. As shown in FIGS. 8A and 8B, a three-dimensional imaging determination flag is sent from the interchangeable lens unit to the camera body in the initial communication performed between the camera body and the interchangeable lens unit when the power is turned on or when the interchangeable lens unit is mounted to the camera body.

If a three-dimensional imaging determination flag has been raised, that interchangeable lens unit is compatible with three-dimensional imaging, but if a three-dimensional imaging determination flag has not been raised, that interchangeable lens unit is not compatible with three-dimensional imaging. A region not used for an ordinary interchangeable lens unit that is not compatible with three-dimensional imaging is used for the address of the three-dimensional imaging determination flag. Consequently, with an interchangeable lens unit that is not compatible with three-dimensional imaging, a state may result in which a three-dimensional imaging determination flag is not raised even though no setting of a three-dimensional imaging determination flag has been performed.

Lens Characteristic Information F2

The lens characteristic information F2 is data indicating the characteristics of the optical system of the interchangeable lens unit, and includes the following parameters and flags, as shown in FIG. 7B.

(A) Stereo Base

Stereo base L1 of the stereo optical system (G)

(B) Optical Axis Position

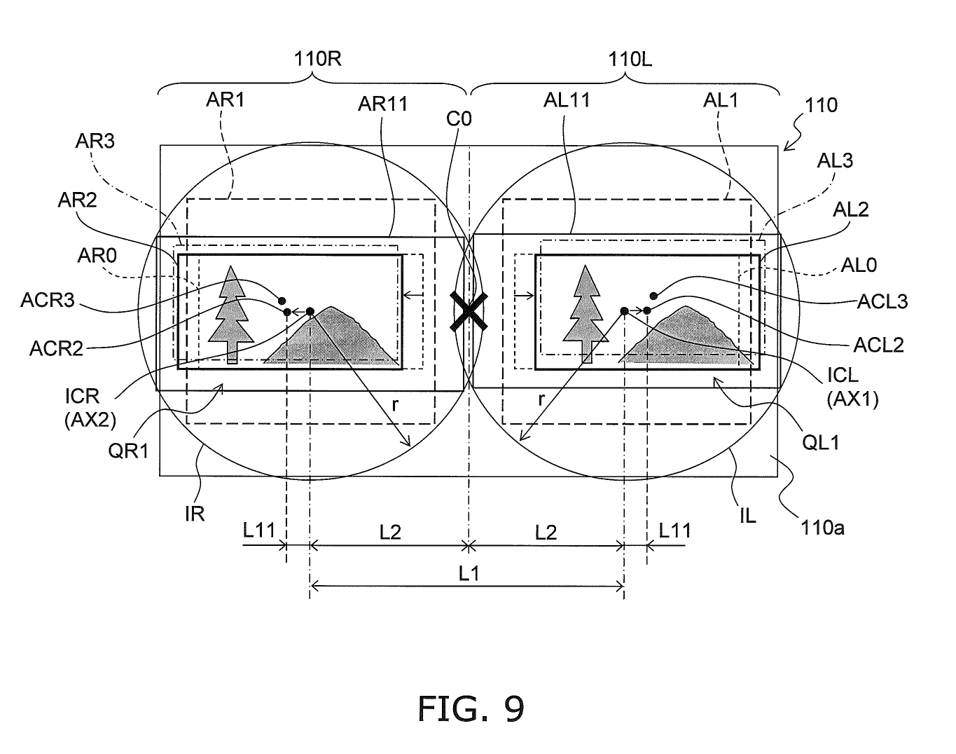

Distance L2 (design value) from the center C0 (see FIG. 9) of the imaging element (the CMOS image sensor 110) to the optical axis center (the center ICR of the image circle IR or the center ICL or the image circle IL shown in FIG. 9)

(C) Angle of Convergence

Angle θ1 formed by the first optical axis (AX1) and the second optical axis (AX2) (see FIG. 10)

(D) Amount of Left-Eye Deviation

Deviation amount DL (horizontal: DLx, vertical: DLy) of the left-eye optical image (QL1) with respect to the optical axis position (design value) of the left-eye optical system (OL) on the imaging element (the CMOS image sensor 110)

(E) Amount of Right-Eye Deviation

Deviation amount DR (horizontal: DRx, vertical: DRy) of the right-eye optical image (QR1) with respect to the optical axis position (design value) of the right-eye optical system (OR) on the imaging element (the CMOS image sensor 110)

(F) Effective Imaging Area

Radius r of the image circles (AL1, AR1) of the left-eye optical system (OL) and the right-eye optical system (OR) (see FIG. 8)

(G) Recommended Convergence Point Distance

Distance L10 from the subject (convergence point P0) to the light receiving face 110a of the CMOS image sensor 110, recommended in performing three-dimensional imaging with the interchangeable lens unit 200 (see FIG. 10)

(H) Extraction Position Correction Amount

Distance L11 from the points (P11 and P12) at which the first optical axis AX1 and the second optical axis AX2 reach the light receiving face 110a when the convergence angle θ1 is zero, to the points (P21 and P22) at which the first optical axis AX1 and the second optical axis AX2 reach the light receiving face 110a when the convergence angle θ1 corresponds to the recommended convergence point distance L1 (see FIG. 10) (Also referred to as the “distance on the imaging element from the reference image extraction position corresponding to when the convergence point distance is at infinity, to the recommended image extraction position corresponding to the recommended convergence point distance of the interchangeable lens unit.”)

(I) Limiting Convergence Point Distance

Limiting distance L12 from the subject to the light receiving face 110a when the extraction range of the left-eye optical image QL1 and the right-eye optical image QR1 are both within the effective imaging area in performing three-dimensional imaging with the interchangeable lens unit 200 (see FIG. 10).

(J) Extraction Position Limiting Correction Amount

Distance L13 from the points (P11 and P12) at which the first optical axis AX1 and the second optical axis AX2 reach the light receiving face 110a when the convergence angle θ1 is zero, to the points (P31 and P32) at which the first optical axis AX1 and the second optical axis AX2 reach the light receiving face 110a when the convergence angle θ1 corresponds to the limiting convergence point distance L12 (see FIG. 10)

Of the above parameters, the optical axis position, the left-eye deviation, and the right-eye deviation are parameters characteristic of a side-by-side imaging type of three-dimensional optical system.

The above parameters will now be described through reference to FIGS. 9 and 10. FIG. 9 is a diagram of the CMOS image sensor 110 as viewed from the subject side. The CMOS image sensor 110 has a light receiving face 110a (see FIGS. 9 and 10) that receives light that has passed through the interchangeable lens unit 200. An optical image of the subject is formed on the light receiving face 110a. As shown in FIG. 9, the light receiving face 110a has a first region 110L and a second region 110R disposed adjacent to the first region 110L. The surface area of the first region 110L is the same as the surface area of the second region 110R. As shown in FIG. 9, when viewed from the rear face side of the camera body 100 (a see-through view), the first region 110L accounts for the left half of the light receiving face 110a, and the second region 110R accounts for the right half of the light receiving face 110a. As shown in FIG. 9, when imaging is performed using the interchangeable lens unit 200, a left-eye optical image QL1 is formed in the first region 110L, and a right-eye optical image QR1 is formed in the second region 110R.

As shown in FIG. 9, the image circle IL of the left-eye optical system OL and the image circle IR of the right-eye optical system OR are defined for design purposes on the CMOS image sensor 110. The center ICL of the image circle IL (an example of a reference image extraction position) coincides with the designed position of the first optical axis AX10 of the left-eye optical system OL, and the center ICR of the image circle IR (an example of a reference image extraction position) coincides with the designed position of the second optical axis AX20 of the right-eye optical system OR. Here, the “designed position” corresponds to a case in which the first optical axis AX10 and the second optical axis AX20 have their convergence point at infinity. Therefore, the designed stereo base is the designed distance L1 between the first optical axis AX10 and the second optical axis AX20 on the CMOS image sensor 110. Also, the optical axis position is the designed distance L2 between the center C0 of the light receiving face 110a and the first optical axis AX10 (or the designed distance L2 between the center C0 and the second optical axis AX20).

As shown in FIG. 9, an extractable range AL1 and a horizontal imaging-use extractable range AL11 are set on the basis of the center ICL, and an extractable range AR1 and a horizontal imaging-use extractable range AR11 are set on the basis of the center ICR. Since the center ICL is set substantially at the center position of the first region 110L of the light receiving face 110a, wider extractable ranges AL1 and AL11 can be ensured within the image circle IL. Also, since the center ICR is set substantially at the center position of the second region 110R, wider extractable ranges AR1 and AR11 can be ensured within the image circle IR.

The extractable ranges AL0 and AR0 shown in FIG. 9 are regions serving as a reference in extracting left-eye image data and right-eye image data. The designed extractable range AL0 for left-eye image data is set using the center ICL of the image circle IL (or the first optical axis AX10) as a reference, and is positioned at the center of the extractable range AL1. Also, the designed extractable range AR0 for right-eye image data is set using the center ICR of the image circle IR (or the second optical axis AX20) as a reference, and is positioned at the center of the extractable range AR1.

However, since the optical axis centers ICL and ICR corresponding to a case in which the convergence point is at infinity, if the left-eye image data and right-eye image data are extracted using the extraction regions AL0 and AR0 as a reference, the position at which the subject is reproduced in 3D view will be the infinity position. Therefore, if the interchangeable lens unit 200 is for close-up imaging at this setting (such as when the distance from the imaging position to the subject is about 1 meter), there will be a problem in that the subject will jump out from the screen too much within the three-dimensional image in 3D view.

In view of this, with this camera body 100, the extraction region AR0 is shifted to the recommended extraction region AR3, and the extraction region AL0 to the recommended extraction region AL3, each by a distance L11, so that the distance from the user to the screen in 3D view will be the recommended convergence point distance L10 of the interchangeable lens unit 200. The correction processing of the extraction area using the extraction position correction amount L11 will be described below.

2: Configuration of Camera Body

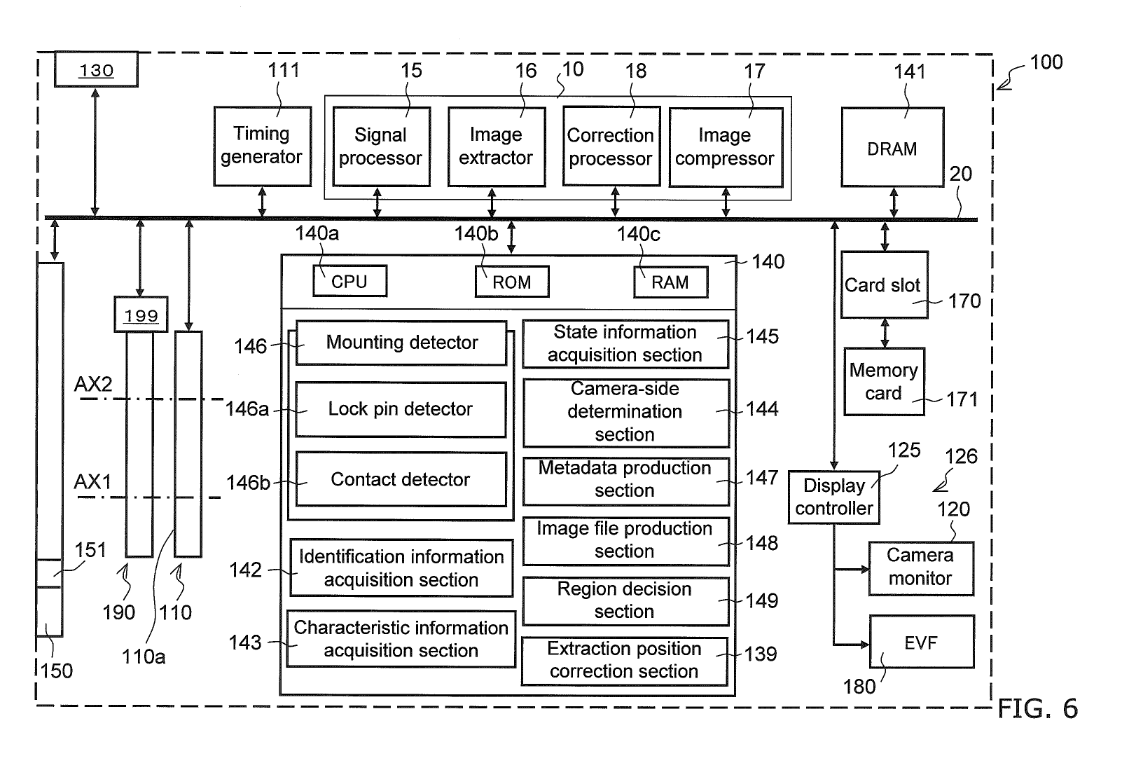

As shown in FIGS. 4 and 6, the camera body 100 comprises the CMOS image sensor 110, a camera monitor 120, an electronic viewfinder 180, a display controller 125, a manipulation unit 130, a card slot 170, a shutter unit 190, the body mount 150, a DRAM 141, an image processor 10, and the camera controller 140 (an example of a controller). These components are connected to a bus 20, allowing data to be exchanged between them via the bus 20.

(1) CMOS Image Sensor 110

The CMOS image sensor 110 converts an optical image of a subject (hereinafter also referred to as a subject image) formed by the interchangeable lens unit 200 into an image signal. As shown in FIG. 6, the CMOS image sensor 110 outputs an image signal on the basis of a timing signal produced by a timing generator 112. The image signal produced by the CMOS image sensor 110 is digitized and converted into image data by a signal processor 15 (discussed below). The CMOS image sensor 110 can acquire still picture data and moving picture data. The acquired moving picture data is also used for the display of a through-image.

The “through-image” referred to here is an image, out of the moving picture data, that is not recorded to a memory card 171. The through-image is mainly a moving picture, and is displayed on the camera monitor 120 or the electronic viewfinder (hereinafter also referred to as EVF) 180 in order to compose a moving picture or still picture.

As discussed above, the CMOS image sensor 110 has the light receiving face 110a (see FIGS. 6 and 9) that receives light that has passed through the interchangeable lens unit 200. An optical image of the subject is formed on the light receiving face 110a. As shown in FIG. 9, when viewed from the rear face side of the camera body 100, the first region 110L accounts for the left half of the light receiving face 110a, while the second region 11)R accounts for the right half When imaging is performed with the interchangeable lens unit 200, a left-eye optical image is formed in the first region 110L, and a right-eye optical image is formed in the second region 110R.

The CMOS image sensor 110 is an example of an imaging element that converts an optical image of a subject into an electrical image signal. “Imaging element” is a concept that encompasses the CMOS image sensor 110 as well as a CCD image sensor or other such opto-electric conversion element.

(2) Camera Monitor 120

The camera monitor 120 is a liquid crystal display, for example, and displays display-use image data as an image. This display-use image data is image data that has undergone image processing, data for displaying the imaging conditions, operating menu, and so forth of the digital camera 1, or the like, and is produced by the camera controller 140. The camera monitor 120 is capable of selectively displaying both moving and still pictures. As shown in FIG. 5, in this embodiment the camera monitor 120 is disposed on the rear face of the camera body 100, but the camera monitor 120 may be disposed anywhere on the camera body 100.

The camera monitor 120 is an example of a display section provided to the camera body 100. The display section could also be an organic electroluminescence component, an inorganic electroluminescence component, a plasma display panel, or another such device that allows images to be displayed.

(3) Electronic Viewfinder 180

The electronic viewfinder 180 displays as an image the display-use image data produced by the camera controller 140. The EVF 180 is capable of selectively displaying both moving and still pictures. The EVF 180 and the camera monitor 120 may both display the same content, or may display different content. They are both controlled by the display controller 125.

(4) Display Controller 125

The display controller 125 controls the camera monitor 120 and the electronic viewfinder 180. More specifically, the display controller 125 produces display-use image data that will serve as the basis for the image displayed on the camera monitor 120 and the electronic viewfinder 180, and displays the image on the camera monitor 120 and the electronic viewfinder 180 on the basis of this display-use image data. The display controller 125 adjusts the size of the image data that has undergone correction processing, and produces display-use image data. A menu setting unit 126 (an example of an image display section) that displays images is constituted by the camera monitor 120, the electronic viewfinder 180, and the display controller 125.

The image display section 126 switches the display state on the basis of the detection result of a mounting detector 146. More precisely, the display controller 125 controls the camera monitor 120 and the electronic viewfinder 180 so that the display state is switched on the basis of the detection result of the mounting detector 146. The image display section 126 starts live-view display after the mounting of an interchangeable lens unit 200 to a body mount 150 has been completed. The term “live-view display” refers to displaying a captured image in real time on the basis of image data obtained by a CMOS image sensor 110 (stereo image data in the case of three-dimensional imaging), for example. The image display section 126 can switch between live-view display and another display (such as black screen display). The image display section 126 restricts the real-time display of a subject until the mounting of the interchangeable lens unit 200 to the body mount 150 has been completed. More precisely, the image display section 126 maintains a black screen display until the mounting of the interchangeable lens unit 200 to the body mount 150 has been completed, and then switches the display state from a black screen display state to a live-view display state once the mounting of the interchangeable lens unit 200 to the body mount 150 has been completed. Further, the image display section 126 switches the display state from a live-view display state to a black screen display state when removal of the interchangeable lens unit 200 from the body mount 150 is begun.

Here, the live-view display state is an example of a first display state, and the black screen display state is an example of a second display state. “Black screen display” encompasses a situation in which black is displayed on the camera monitor 120 or the electronic viewfinder 180, as well as a situation in which display itself is halted on the camera monitor 120 or the electronic viewfinder 180.

(5) Manipulation Component 130

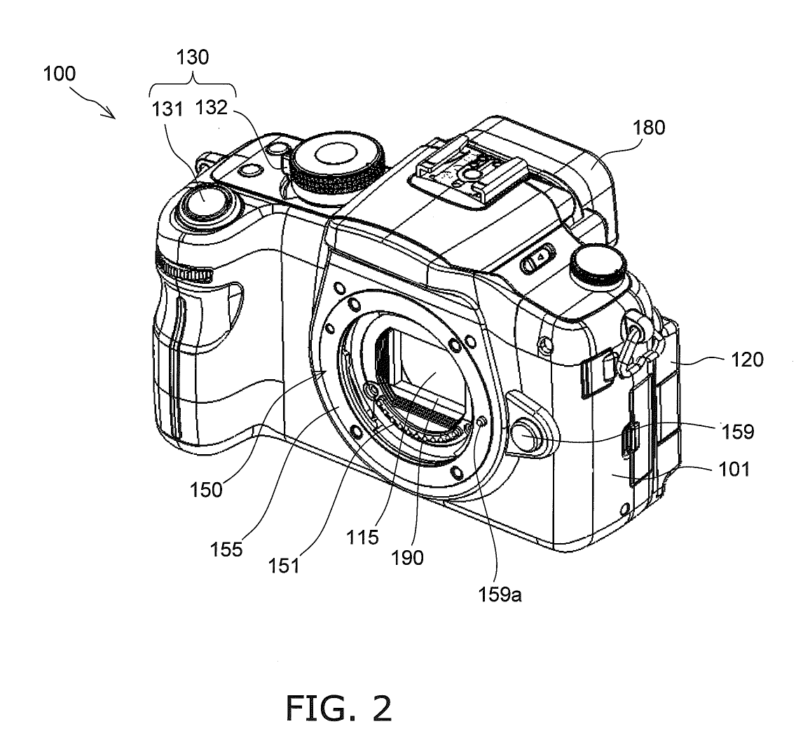

As shown in FIGS. 1 and 2, the manipulation unit 130 has a release button 131 and a power switch 132. The release button 131 is used for shutter operation by the user. The power switch 132 is a rotary lever switch provided to the top face of the camera body 100. The manipulation unit 130 can be anything that receives operation by the user, and includes a button, a lever, a dial, a touch panel, and so forth.

(6) Card Slot 170

The card slot 170 allows the memory card 171 to be inserted. The card slot 170 controls the memory card 171 on the basis of control from the camera controller 140. More specifically, the card slot 170 stores image data on the memory card 171 and outputs image data from the memory card 171. For example, the card slot 170 stores moving picture data on the memory card 171 and outputs moving picture data from the memory card 171.

The memory card 171 is able to store the image data produced by the camera controller 140 in image processing. For instance, the memory card 171 can store uncompressed raw image files, compressed JPEG image files, or the like. Furthermore, the memory card 171 can store stereo image files in multi-picture format (MPF).

Also, image data that have been internally stored ahead of time can be outputted from the memory card 171 via the card slot 170. The image data or image files outputted from the memory card 171 are subjected to image processing by the camera controller 140. For example, the camera controller 140 produces display-use image data by subjecting the image data or image files acquired from the memory card 171 to expansion or the like.

The memory card 171 is further able to store moving picture data produced by the camera controller 140 in image processing. For instance, the memory card 171 can store moving picture files compressed according to H.264/AVC, which is a moving picture compression standard. Stereo moving picture files can also be stored. The memory card 171 can also output, via the card slot 170, moving picture data or moving picture files internally stored ahead of time. The moving picture data or moving picture files outputted from the memory card 171 are subjected to image processing by the camera controller 140. For example, the camera controller 140 subjects the moving picture data or moving picture files acquired from the memory card 171 to expansion processing and produces display-use moving picture data.

(7) Shutter Unit 190

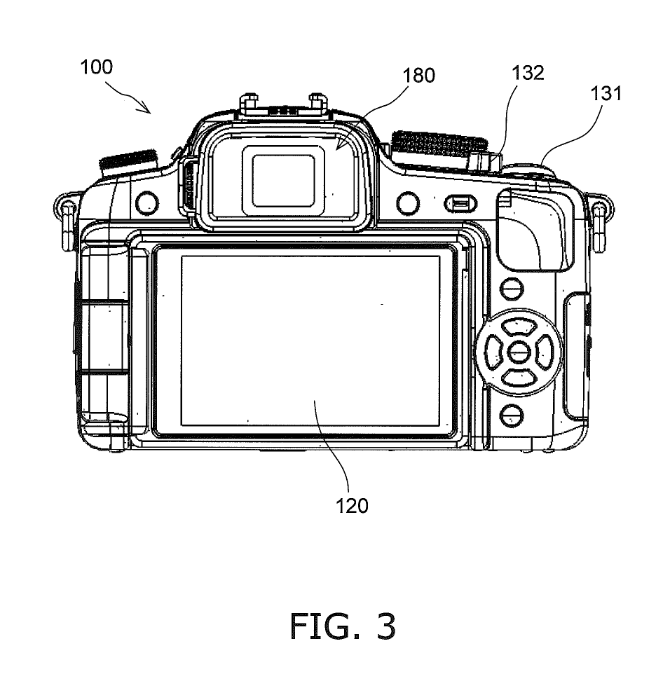

The shutter unit 190 is what is known as a focal plane shutter, and is disposed between the body mount 150 and the CMOS image sensor 110, as shown in FIG. 3. The charging of the shutter unit 190 is performed by a shutter motor 199. The shutter motor 199 is a stepping motor, for example, and is controlled by the camera controller 140.

(8) Body Mount 150

The body mount 150 allows the interchangeable lens unit 200 to be mounted, and holds the interchangeable lens unit 200 in a state in which the interchangeable lens unit 200 is mounted. The body mount 150 can be mechanically and electrically connected to the lens mount 250 of the interchangeable lens unit 200. Data and/or control signals can be sent and received between the camera body 100 and the interchangeable lens unit 200 via the body mount 150 and the lens mount 250. More specifically, the body mount 150 and the lens mount 250 send and receive data and/or control signals between the camera controller 140 and the lens controller 240.

The body mount 150 has a mounting ring 155, a body-side terminal 151 (an example of an electrical contact), and a lens removal button 159. The mounting ring 155 is fixed to a housing 101. The body-side terminal 151 is used to electrically connect the camera body 100 to the interchangeable lens unit 200, and is fixed to the mounting ring 155, for example. The body-side terminal 151 is electrically connected to a camera controller 140 and a power supply 160. The lens removal button 159 is operated when the interchangeable lens unit 200 is to be removed. The lens removal button 159 is movably supported by the housing 101. The lens removal button 159 will be discussed in detail below.

(9) Camera Controller 140

The camera controller 140 controls the entire camera body 100. The camera controller 140 is electrically connected to the manipulation unit 130. Manipulation signals from the manipulation unit 130 are inputted to the camera controller 140. The camera controller 140 uses the DRAM 141 as a working memory during control operation or image processing operation.

Also, the camera controller 140 sends signals for controlling the interchangeable lens unit 200 through the body mount 150 and the lens mount 250 to the lens controller 240, and indirectly controls the various components of the interchangeable lens unit 200. The camera controller 140 also receives various kinds of signal from the lens controller 240 via the body mount 150 and the lens mount 250.

The camera controller 140 has a CPU (central processing unit) 140a, a ROM (read only memory) 140b, and a RAM (random access memory) 140c, and can perform various functions by reading the programs stored in the ROM 140b (an example of a computer-readable storage medium) into the CPU 140a.

Details of Camera Controller 140

The functions of the camera controller 140 will now be described in detail.

First, the camera controller 140 has a function of detecting the mounting state of the interchangeable lens unit 200 with respect to the camera body 100 (more precisely, the body mount 150). More specifically, as shown in FIG. 6, the camera controller 140 has the mounting detector 146. The mounting detector 146 has a lock pin detector 146a and a contact detector 146b. The lock pin detector 146a (an example of a first detector) detects the state of the lens removal button 159, and thereby detects whether or not the interchangeable lens unit is being attached to or removed from the body mount 150. More specifically, the lock pin detector 146a detects whether or not the lens removal button 159 (more precisely, a lock pin 159a) has been pressed. The contact detector 146b (an example of a second detector) is electrically connected to the body-side terminal 151, and detects whether or not the camera body 100 is electrically connected to the interchangeable lens unit 200 (whether or not the body-side terminal 151 electrically connected to the interchangeable lens unit 200).

The camera controller 140 has various other functions, such as a function of determining whether or not the interchangeable lens unit mounted to the body mount 150 is compatible with three-dimensional imaging, and a function of acquiring information related to three-dimensional imaging from the interchangeable lens unit. The camera controller 140 has an identification information acquisition section 142, a characteristic information acquisition section 143, a camera-side determination section 144, a state information acquisition section 145, an extraction position correction section 139, a region decision section 149, a metadata production section 147, and an image file production section 148.

The identification information acquisition section 142 acquires the lens identification information F1, which indicates whether or not the interchangeable lens unit 200 is compatible with three-dimensional imaging, from the interchangeable lens unit 200 mounted to the body mount 150. As shown in FIG. 7A, the lens identification information F1 is information indicating whether or not the interchangeable lens unit mounted to the body mount 150 is compatible with three-dimensional imaging, and is stored in the flash memory 242 of the lens controller 240, for example. The lens identification information F1 is a three-dimensional imaging determination flag stored at a specific address in the flash memory 242. The identification information acquisition section 142 temporarily stores the acquired lens identification information F1 in the DRAM 141, for example.

The camera-side determination section 144 determines whether or not the interchangeable lens unit 200 mounted to the body mount 150 is compatible with three-dimensional imaging on the basis of the lens identification information F1 acquired by the identification information acquisition section 142. If it is determined by the camera-side determination section 144 that the interchangeable lens unit 200 mounted to the body mount 150 is compatible with three-dimensional imaging, the camera controller 140 allows the execution of a three-dimensional imaging mode. On the other hand, if it is determined by the camera-side determination section 144 that the interchangeable lens unit 200 mounted to the body mount 150 is not compatible with three-dimensional imaging, the camera controller 140 does not execute the three-dimensional imaging mode. In this case, the camera controller 140 allows the execution of a two-dimensional imaging mode.

The characteristic information acquisition section 143 (an example of a correction information acquisition section) acquires lens characteristic information F2, which indicates the characteristics of the optical system installed in the interchangeable lens unit 200, from the interchangeable lens unit 200. More specifically, the characteristic information acquisition section 143 acquires the above-mentioned lens characteristic information F2 from the interchangeable lens unit 200 when the camera-side determination section 144 has determined that the interchangeable lens unit 200 is compatible with three-dimensional imaging. The characteristic information acquisition section 143 temporarily stores the acquired lens characteristic information F2 in the DRAM 141, for example.

The state information acquisition section 145 acquires the lens state information F3 (imaging possibility flag) produced by the state information production section 243. This lens state information F3 is used in determining whether or not the interchangeable lens unit 200 is in a state that allows imaging. The state infatuation acquisition section 145 temporarily stores the acquired lens state information F3 in the DRAM 141, for example.

The extraction position correction section 139 corrects the center positions of the extraction regions AL0 and AR0 on the basis of the extraction position correction amount L11. In the initial state, the center of the extraction region AL0 is set to the center ICL of the image circle IL, and the center of the extraction region AR0 is set to the center ICR of the image circle IR. The extraction position correction section 139 moves the extraction centers horizontally by the extraction position correction amount L11 from the centers ICL and ICR, and sets them to new extraction centers ACL2 and ACR2 (examples of recommended image extraction positions) as a reference for extracting left-eye image data and right-eye image data. The extraction regions using the extraction centers ACL2 and ACR2 as a reference are the extraction regions AL2 and AR2 shown in FIG. 9. Thus using the extraction position correction amount L11 to correct the positions of the extraction centers allows the extraction regions to be set according to the characteristics of the interchangeable lens unit, and allows a better stereo image to be obtained.

In this embodiment, since the interchangeable lens unit 200 has a zoom function, if the focal length changes as a result of zooming, the recommended convergence point distance L10 changes, and this is accompanied by a change in the extraction position correction amount L11. Therefore, the extraction position correction amount L11 may be recalculated by computation according to the zoom position.

More specifically, the lens controller 240 can ascertain the zoom position on the basis of the detection result of a zoom position sensor (not shown). The lens controller 240 sends the zoom position information to the camera controller 140 at a specific period. The zoom position information is temporarily stored in the DRAM 141.

Meanwhile, the extraction position correction section 139 calculates the extraction position correction amount suited to the focal distance on the basis of the zoom position information, the recommended convergence point distance L10, and the extraction position correction amount L11, for example. At this point, for example, information indicating the relation between the zoom position information, the recommended convergence point distance L10, and the extraction position correction amount L11 (such as a computational formula or a data table) may be stored in the camera body 100, or may be stored in the flash memory 242 of the interchangeable lens unit 200. Updating of the extraction position correction amount is carried out at a specific period. The updated extraction position correction amount is stored at a specific address in the DRAM 141. In this case, the extraction position correction section 139 corrects the center positions of the extraction regions AL0 and AR0 on the basis of the newly calculated extraction position correction amount, just as with the extraction position correction amount L11.

The region decision section 149 decides the size and position of the extraction regions AL3 and AR3 used in extracting left-eye image data and right-eye image data with the image extractor 16. More specifically, the region decision section 149 decides the size and position of the extraction regions AL3 and AR3 of the left-eye image data and the right-eye image data on the basis of the extraction centers ACL2 and ACR2 calculated by the extraction position correction section 139, the radius r of the image circles IL and IR, and the left-eye deviation amount DL and right-eye deviation amount DR included in the lens characteristic information F2.

The region decision section 149 may also decide the starting point for extraction processing on the image data, so that the left-eye image data and right-eye image data can be properly extracted, on the basis of a 180-degree rotation flag indicating whether or not the left-eye optical system and the right-eye optical system are rotated, a layout change flag indicating the left and right layout of the left-eye optical system and right-eye optical system, and a mirror inversion flag indicating whether or not the left-eye optical system and right-eye optical system have undergone mirror inversion.

The metadata production section 147 produces metadata with set stereo base and angle of convergence. The stereo base and angle of convergence are used in displaying a stereo image.

The image file production section 148 produces MPF stereo image files by combining metadata with left- and right-eye image data compressed by an image compressor 17 (discussed below). The image files thus produced are sent to the card slot 170 and stored on the memory card 171, for example.

(10) Image Processor 10

The image processor 10 has the signal processor 15, the image extractor 16, the correction processor 18, and the image compressor 17.

The signal processor 15 digitizes the image signal produced by the CMOS image sensor 110, and produces basic image data for the optical image formed on the CMOS image sensor 110. More specifically, the signal processor 15 converts the image signal outputted from the CMOS image sensor 110 into a digital signal, and subjects this digital signal to digital signal processing such as noise elimination or contour enhancement. The image data produced by the signal processor 15 is temporarily stored as raw data in the DRAM 141. Herein, the image data produced by the signal processor 15 shall be called basic image data.

The image extractor 16 extracts left-eye image data and right-eye image data from the basic image data produced by the signal processor 15. The left-eye image data corresponds to part of the left-eye optical image QL1 formed by the left-eye optical system OL. The right-eye image data corresponds to part of the right-eye optical image QR1 formed by the right-eye optical system OR. The image extractor 16 extracts left-eye image data and right-eye image data from the basic image data held in the DRAM 141, on the basis of the extraction regions AL3 and AR3 decided by the second region decision section 149. The left-eye image data and right-eye image data extracted by the image extractor 16 are temporarily stored in the DRAM 141.

The correction processor 18 performs shading correction and other such correction processing on the extracted left-eye image data and the right-eye image data. In two-dimensional imaging and three-dimensional imaging, the correction processor 18 does not perform distortion correction. After this correction processing, the left-eye image data and right-eye image data are temporarily stored in the DRAM 141.

The image compressor 17 performs compression processing on the corrected left- and right-eye image data stored in the DRAM 141, on the basis of a command from the camera controller 140. This compression processing reduces the image data to a smaller size than that of the original data. An example of the method for compressing the image data is the JPEG (Joint Photographic Experts Group) method in which compression is performed on the image data for each frame. The compressed left-eye image data and right-eye image data are temporarily stored in the DRAM 141.

3: Detecting Mounting State of Interchangeable Lens Unit

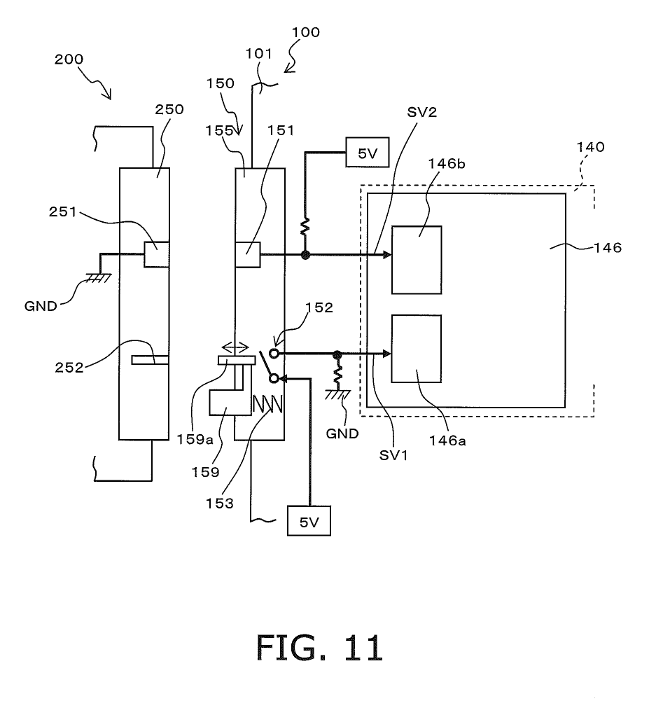

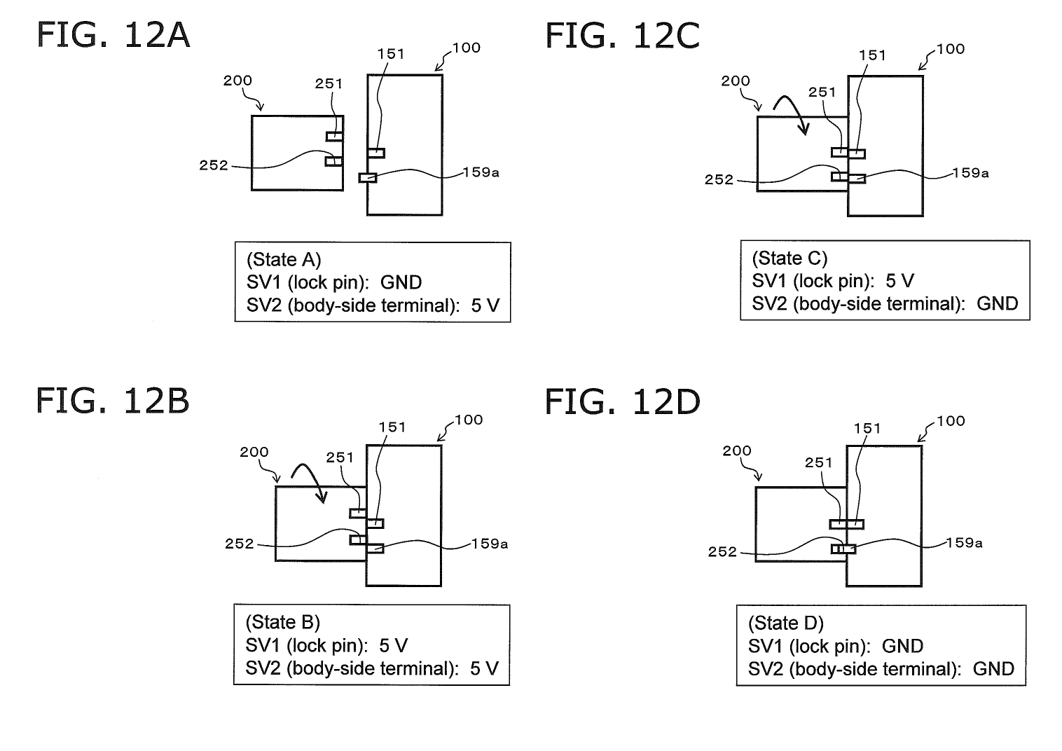

With the camera body 100, the display state of the display section (the camera monitor 120 and the electronic viewfmder 180) is automatically switched according to the mounting state of the interchangeable lens unit. This display switching function will now be described through reference to FIGS. 11 and 12A to 12D. FIG. 11 is a simplified diagram of the area around the body mount 150 and the lens mount 250. FIGS. 12A to 12D show the mounting state of the interchangeable lens unit 200.

(1) Configuration

The digital camera 1 has the configuration shown in FIG. 11 in order to detect the mounting state of the interchangeable lens unit 200 with respect to the camera body 100. More specifically, the lens removal button 159 of the camera body 100 is supported movably within a specific range by the body mount 150 or the housing 101, and is pushed to the interchangeable lens unit 200 side by a spring 153. The position of the lens removal button 159 is maintained by the spring 153.

The lens removal button 159 has the lock pin 159a. The lock pin 159a serves to position the interchangeable lens unit 200 in the rotational direction with respect to the camera body 100. In a state in which the lens removal button 159 is not pressed (that is, in a state in which the lens removal button 159 is being supported by the spring 153), the lock pin 159a sticks out from the body mount 150. When the lens removal button 159 is pressed, the lock pin 159a goes into the body mount 150.

In a state in which the mounting of the interchangeable lens unit 200 has been completed, the lock pin 159a is inserted into a lock hole 252 of the lens mount 250. When the lock pin 159a has been inserted into the lock hole 252, the interchangeable lens unit 200 is positioned at a specific position with respect to the camera body 100. This specific position will be referred to here as the usage position. When the interchangeable lens unit 200 is in the midst of being mounted, the lock pin 159a is pushed into the interior of the body mount 150 by the lens mount 250, and as this happens the lens removal button 159 is also pushed in. That is, the state of the lens removal button 159 can serve as reference information in determining the mounting state of the interchangeable lens unit 200.

A switch 152 is built into the body mount 150 in order to detect the state of the lens removal button 159. The switch 152 is a switch that is normally open, and is electrically connected to the mounting detector 146 of the camera controller 140. More precisely, the switch 152 is electrically connected to the lock pin detector 146a of the mounting detector 146.

The switch 152 has a first detection line SV1 that is connected to the lock pin detector 146a. The first detection line SV1 is also connected to ground (GND). A signal voltage (such as 5 V) is applied to a second line on the opposite side from the first detection line SV1.

When the lens removal button 159 is pressed, this switch 152 is switched on, and the lock pin detector 146a detects that the signal voltage of the first detection line SV1 changes from the ground level (0 V) to 5 V. Similarly, when the lock pin 159a is pushed in, the switch 152 is switched on, and the lock pin detector 146a detects a change in the signal voltage at the first detection line SV1. That is, when the signal voltage of the first detection line SV1 is 5 V, the lens removal button 159 and the lock pin 159a are pushed in. Here, the detection result of the lock pin detector 146a when the first detection line SV1 is 5 V shall be assumed to be “on.”

On the other hand, when the lens removal button 159 is released, the pressing force of the spring 153 causes the lens removal button 159 to stop in a depressed state, and the switch 152 is switched off. In this state, the signal voltage detected at the first detection line SV1 by the lock pin detector 146a falls to the ground level. That is, when the signal voltage of the first detection line SV1 is at the ground level, the lens removal button 159 and the lock pin 159a are not pushed in. Here, the detection result of the lock pin detector 146a when the first detection line SV1 is at the ground level shall be assumed to be “off.”

Thus, the mounting detector 146 can also detect the operational state of the lens removal button 159, as well as the protrusion state of the lock pin 159a, by detecting the level of the signal voltage of the first detection line SV1 with the lock pin detector 146a.

Also, whether or not the interchangeable lens unit 200 is mounted to the camera body 100 can be detected by terminals provided to the body mount 150 and the lens mount 250. More specifically, as shown in FIGS. 4 and 11, the body-side terminal 151 is provided to the body mount 150, and a lens-side terminal 251 is provided to the lens mount 250. The body-side terminal 151 is electrically connected to the contact detector 146b of the mounting detector 146. A signal voltage (such as 5 V) from a battery 22 is applied to a second detection line SV2 that connects the body-side terminal 151 and the contact detector 146b. The lens-side terminal 251 is connected to ground (GND). A voltage (such as 5 V) from the battery 22 is applied to the body-side terminal 151. Here, the detection result of the contact detector 146b when the second detection line SV2 is at 5 V shall be assumed to be “off.”

When a signal voltage is detected by the contact detector 146b at the second detection line SV2, the body-side terminal 151 is not connected to the lens-side terminal 251. When the body-side terminal 151 comes into contact with the lens-side terminal 251, the signal voltage detected at the second detection line SV2 by the contact detector 146b falls to the ground level. Here, the detection result of the contact detector 146b when the second detection line SV2 is at the ground level shall be assumed to be “on.”

Thus, when the contact detector 146b detects the level of the signal voltage of the second detection line SV2, the camera controller 140 can detect whether or not the body-side terminal 151 is in contact with the lens-side terminal 251, and can detect whether or not the interchangeable lens unit 200 is mounted to the camera body 100. Whether or not the interchangeable lens unit 200 is disposed substantially at the specified position with respect to the camera body 100 can be determined from the detection result of the contact detector 146b.

Even in a state in which the body-side terminal 151 is in contact with the lens-side terminal 251, the interchangeable lens unit 200 is not necessarily completely mounted to the camera body 100, but at least whether or not the body mount 150 and the lens mount 250 are in contact can be decided by monitoring the signal voltage of the second detection line SV2 with the contact detector 146b.

As described above, the mounting state of the interchangeable lens unit 200 (states A to D) with respect to the camera body 100 can be determined on the basis of the detection results of the lock pin detector 146a and the contact detector 146b.

(2) Detection Operation During Interchangeable Lens Unit Mounting

As shown in FIG. 12A, for example, in a state in which the interchangeable lens unit 200 has been completely removed from the camera body 100, the signal voltage of the first detection line SV1 is at the ground level (off), and the signal voltage of the second detection line SV2 is 5 V (on). The state shown in FIG. 12A shall be termed state A.

For example, in the mounting of the interchangeable lens unit 200 to the camera body 100, the lens mount 250 is fitted to the body mount 150. More specifically, a plurality of prongs (not shown) are provided to the lens mount 250, and the body mount 150 is provided with a plurality of grooves (not shown) into which these prongs are inserted in the rotational direction. When the interchangeable lens unit 200 is rotated clockwise with respect to the camera body 100 in a state in which the lens mount 250 is pressed against the body mount 150, the prongs fit into the grooves, and the movement of the interchangeable lens unit 200 with respect to the camera body 100 in a direction along the optical axes AX1 and AX2 is restricted. At this point, as shown in FIG. 12B, since the lock pin 159a is pushed in by the lens mount 250, the signal voltage of the first detection line SV1 changes to 5 V, and the change in signal voltage is detected by the lock pin detector 146a. That is, the detection result of the lock pin detector 146a changes from “off” to “on.” Consequently, it can be detected that the mounting of the interchangeable lens unit 200 has begun.

In state B, the body-side terminal 151 is not in contact with the lens-side terminal 251, so the signal voltage of the second detection line SV2 is 5 V (off).

When the interchangeable lens unit 200 is further rotated with respect to the camera body 100, the body-side terminal 151 comes into contact with the lens-side terminal 251. As a result, the signal voltage of the second detection line SV2 changes from 5 V (off) to the ground level (on). Thus, when the signal voltage of the first detection line SV1 is 5 V (when the detection result of the lock pin detector 146a is “on”) and the signal voltage of the second detection line SV2 is at the ground level (when the detection result of the contact detector 146b is “on”), the mounting state of the interchangeable lens unit 200 can be determined to be the state C shown in FIG. 12C.

When the interchangeable lens unit 200 is further rotated with respect to the camera body 100, lock pin 159a is inserted into the lock hole 252 of the lens mount 250, and rotation of the interchangeable lens unit 200 with respect to the camera body 100 is restricted. A state in which the lock pin 159a has been inserted into the lock hole 252 is a state in which the interchangeable lens unit 200 has been completely mounted to the camera body 100. Since the lock pin 159a is inserted into the lock hole 252, the lens removal button 159 returns to its normal state, and the signal voltage of the first detection line SV1 changes from 5 V (on) to the ground level (off). Thus, when the signal voltage of the first detection line SV1 is at the ground level (off), and the signal voltage of the second detection line SV2 is at the ground level (on), it can be determined that the mounting state of the interchangeable lens unit 200 is the state D shown in FIG. 12D.

(3) Detection Operation During Interchangeable Lens Unit Removal

When the interchangeable lens unit 200 is removed from the camera body 100, the lens removal button 159 is pressed and the locking by the lock pin 159a is released. When the lens removal button 159 is pressed, the signal voltage of the first detection line SV1 changes from the ground level (off) to 5 V (on), so the mounting detector 146 can detect the start of removal of the interchangeable lens unit 200 when the lock pin detector 146a detects a change in signal voltage.

Thereafter, just as during mounting as discussed above, the mounting state of the interchangeable lens unit 200 with respect to the camera body 100 (states A to D) can be determined on the basis of the detection results of the lock pin detector 146a and the contact detector 146b, as shown in FIGS. 12A to 12D.

Operation of Digital Camera

(1) When Power is On

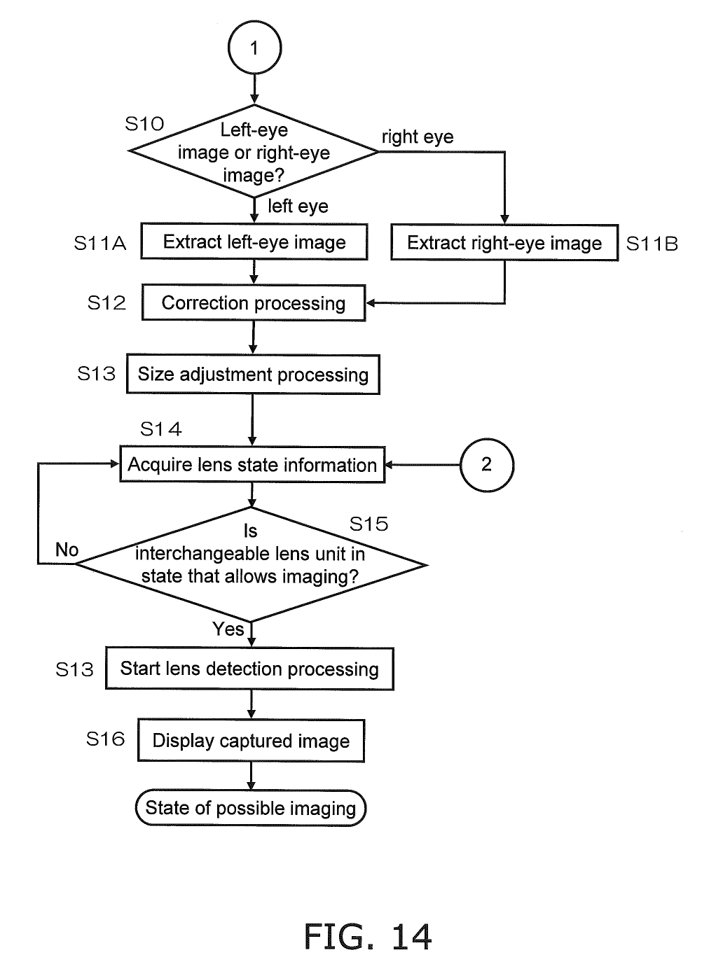

Determination of whether or not the interchangeable lens unit 200 is compatible with three-dimensional imaging is possible either when the interchangeable lens unit 200 is mounted to the camera body 100 in a state in which the power to the camera body 100 is on, or when the power is turned on to the camera body 100 in a state in which the interchangeable lens unit 200 has been mounted to the camera body 100. Here, the latter case will be used as an example to describe the operation of the digital camera 1 through reference to the flowcharts in FIGS. 8A, 8B, 13, and 14. Of course, the same operation may also be performed in the former case.

When the power is turned on, a black screen is displayed on the camera monitor 120 under control of the display controller 125, and the blackout state of the camera monitor 120 is maintained (step S1). Next, the identification information acquisition section 142 of the camera controller 140 acquires the lens identification information F1 from the interchangeable lens unit 200 (step S2). More specifically, as shown in FIGS. 8A and 8B, when the mounting of the interchangeable lens unit 200 is detected by the lens detector 146 of the camera controller 140, the camera controller 140 sends a model confirmation command to the lens controller 240. This model confirmation command is a command that requests the lens controller 240 to send the status of a three-dimensional imaging determination flag for the lens identification information F1. As shown in FIG. 8B, since the interchangeable lens unit 200 is compatible with three-dimensional imaging, upon receiving the model confirmation command, the lens controller 240 sends the lens identification information F1 (three-dimensional imaging determination flag) to the camera body 100. The identification information acquisition section 142 temporarily stores the status of this three-dimensional imaging determination flag in the DRAM 141.

Next, normal initial communication is executed between the camera body 100 and the interchangeable lens unit 200 (step S3). This normal initial communication is also performed between the camera body and an interchangeable lens unit that is not compatible with three-dimensional imaging For example, information related to the specifications of the interchangeable lens unit 200 (its focal length, F stop value, etc.) is sent from the interchangeable lens unit 200 to the camera body 100.

After normal initial communication, the camera-side determination section 144 determines whether or not the interchangeable lens unit 200 mounted to the body mount 150 is compatible with three-dimensional imaging (step S4). More specifically, the camera-side determination section 144 determines whether or not the mounted interchangeable lens unit 200 is compatible with three-dimensional imaging on the basis of the lens identification information F1 (three-dimensional imaging determination flag) acquired by the identification information acquisition section 142.

If the mounted interchangeable lens unit is not compatible with three-dimensional imaging, a normal sequence corresponding to two-dimensional imaging is executed, and the processing moves to step S14 (step S8). If an interchangeable lens unit that is compatible with three-dimensional imaging (such as the interchangeable lens unit 200) is mounted, lens characteristic information F2 is acquired by the characteristic information acquisition section 143 from the interchangeable lens unit 200 (step S5). More specifically, as shown in FIG. 8B, a characteristic information transmission command is sent from the characteristic information acquisition section 143 to the lens controller 240. This characteristic information transmission command is a command requesting the transmission of the lens characteristic information F2. Upon receiving this command, the camera controller 140 sends the lens characteristic information F2 to the camera controller 140. The characteristic information acquisition section 143 stores the lens characteristic information F2 in a DRAM 141, for example.

After the acquisition of the lens characteristic information F2, the extraction position correction section 139 corrects the center positions of the extraction regions AL0 and AR0 on the basis of the lens characteristic information F2 (step S6). More specifically, the extraction position correction section 139 corrects the center positions of the extraction regions AL0 and AR0 on the basis of the extraction position correction amount L11 (or an extraction position correction amount newly calculated from the extraction position correction amount L11). The extraction position correction section 139 sets the new extraction centers ACL2 and ACR2 as a reference for extracting left-eye image data and right-eye image data, by moving the extraction centers horizontally by the extraction position correction amount L11 (or an extraction position correction amount newly calculated from the extraction position correction amount L11) from the centers ICL and ICR.

The second region decision section 149 decides the size and extraction method of the extraction regions AL3 and AR3 on the basis of the lens characteristic information F2 (step S7). For example, as discussed above, the second region decision section 149 decides the size of the extraction regions AL3 and AR3 on the basis of the optical axis position, the effective imaging area (radius r), the extraction centers ACL2 and ACR2, the left-eye deviation amount DL, the right-eye deviation amount DR, and the size of the CMOS image sensor 110. For example, the region decision section 149 decides the size of the extraction regions AL3 and AR3 on the basis of the above-mentioned information so that the extraction regions AL3 and AR3 will fit into the lateral imaging-use extractable ranges AL11 and AR11.

A critical convergence point distance L12 and an extraction point critical correction amount L13 may be used when the region decision section 149 decides the extraction regions AL3 and AR3.

Also, the region decision section 149 may decide the extraction method, that is, which of the images of the extraction regions AL3 and AR3 is to be extracted as the right-eye image, whether to rotate the images, and whether the images are to be subjected to mirror inversion.

Furthermore, an image for live-view use is selected from the left-eye and right-eye image data (step S10). For example, the user may select from the left-eye and right-eye image data, or one of these that has been predetermined at the camera controller 140 may be set for display use. The selected image data is set as the display-use image, and is extracted by the image extractor 16 (step S11A or S11B).

Then, the extracted image data is subjected to shading correction or other such correction processing by the correction processor 18 (step S12). In the correction processing in step S12, distortion correction is not performed. The corrected image data is then subjected to size adjustment processing by the display controller 125, and display-use image data is produced (step S13). This correction-use image data is temporarily stored in the DRAM 141.

After this, the state information acquisition section 145 determines whether or not the interchangeable lens unit 200 is in a state that allows imaging (step S14). More specifically, if a lens-side determination section 244 of the interchangeable lens unit 200 receives the above-mentioned characteristic information transmission command, the lens-side determination section 244 determines that the camera body 100 is compatible with three-dimensional imaging (see FIG. 8B). On the other hand, if no characteristic information transmission command is sent from the camera body within a specific length of time, the lens-side determination section 244 determines that the camera body is not compatible with three-dimensional imaging (see FIG. 8A).

Furthermore, the state information production section 243 sets the status of an imaging possibility flag (an example of standby information) indicating whether or not the three-dimensional optical system G is in the proper imaging state, on the basis of the determination result of the lens-side determination section 244. The state information production section 243 sets the status of the imaging possibility flag to “possible” upon completion of the initialization of the various components if the lens-side determination section 244 has determined that the camera body is compatible with three-dimensional imaging (FIG. 8B). On the other hand, the state information production section 243 sets the status of the imaging possibility flag to “impossible,” regardless of whether or not the initialization of the various components has been completed, if the lens-side determination section 244 has determined that the camera body is not compatible with three-dimensional imaging (see FIG. 8A). In step S14, if a command is sent that requests the transmission of status information about the imaging possibility flag from the state information acquisition section 145 to the lens controller 240, the state information production section 243 sends status information about the imaging possibility flag to the camera controller 140. The status information about the imaging possibility flag is sent to the camera controller 140. With the camera body 100, the state information acquisition section 145 temporarily stores the status information about the imaging possibility flag sent from the lens controller 240 at a specific address in the DRAM 141.

Further, the state information acquisition section 145 determines whether or not the interchangeable lens unit 200 is in a state that allows imaging, on the basis of the stored imaging possibility flag (step S15). If the interchangeable lens unit 200 is not in a state that allows imaging, the processing of steps S14 and S15 is repeated for a specific length of time. On the other hand, if the interchangeable lens unit 200 is in a state that allows imaging, the display-use image data produced in step S13 is displayed as a visible image on the camera monitor 120 (step S16). From step S16 onward, a left-eye image, a right-eye image, an image that is a combination of a left-eye image and a right-eye image, or a three-dimensional display using a left-eye image and a right-eye image is displayed in live view on the camera monitor 120, for example.

(2) Three-Dimensional Still Picture Imaging

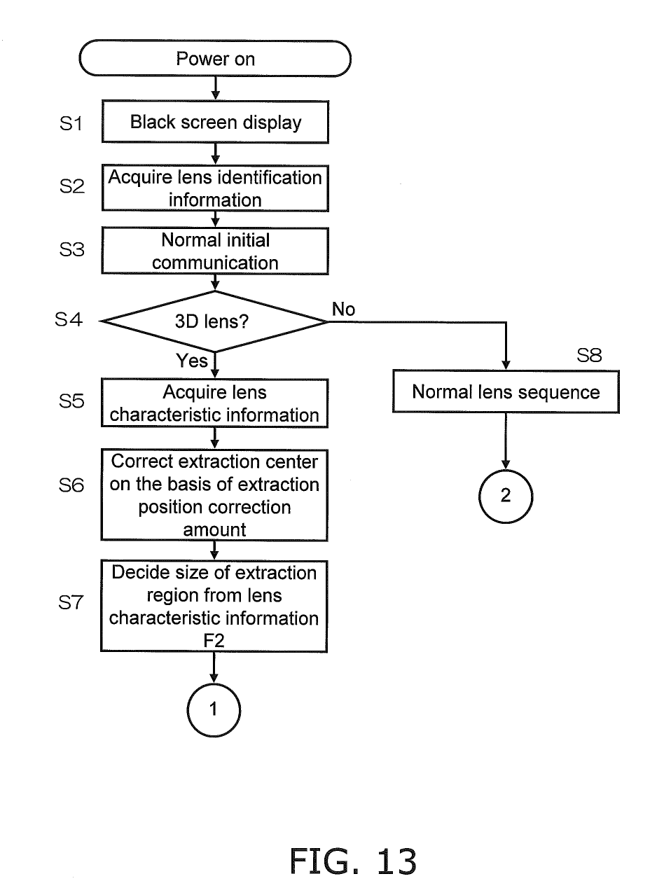

The operation during three-dimensional still picture imaging will now be described through reference to FIG. 13.

When the user presses the release button 131, autofocusing (AF) and automatic exposure (AE) are executed, and then exposure is commenced (steps S21 and S22). An image signal from the CMOS image sensor 110 (full pixel data) is taken in by the signal processor 15, and the image signal is subjected to AD conversion or other such signal processing by the signal processor 15 (steps S23 and S24). The basic image data produced by the signal processor 15 is temporarily stored in the DRAM 141.

Next, left-eye image data and right-eye image data are extracted from the basic image data by the image extractor 16 (step S25). The sizes, positions, and extraction method of the extraction regions AL3 and AR3 at this point are what was decided in steps S6 and S7.

The correction processor 18 subjects the extracted left-eye image data and right-eye image data to correction processing, and the image compressor 17 performs JPEG compression or other such compression processing on the left-eye image data and right-eye image data (steps S26 and S27).

After compression, the metadata production section 147 of the camera controller 140 produces metadata setting the stereo base and the angle of convergence (step S28).

After metadata production, the compressed left- and right-eye image data are combined with the metadata, and MPF image files are produced by the image file production section 148 (step S29). The produced image files are sent to the card slot 170 and stored in the memory card 171, for example. If these image files are displayed in 3D using the stereo base and the angle of convergence, the displayed image can be seen in 3D view using special glasses or the like.

(3) Operation During Interchangeable Lens Unit Mounting

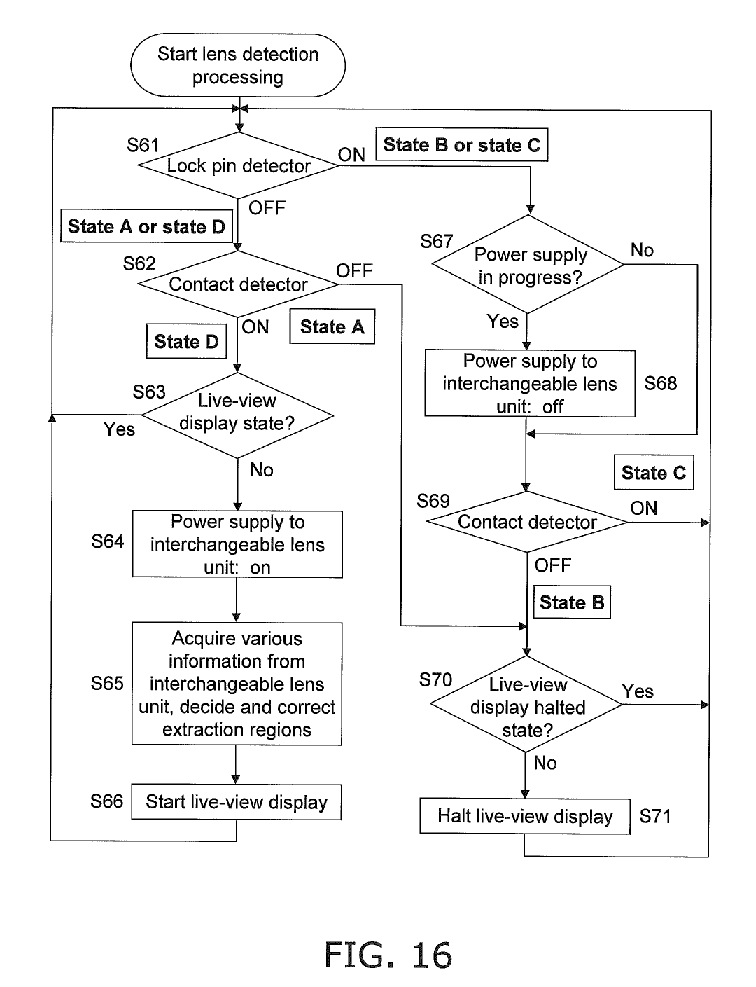

The operation during the mounting of the interchangeable lens unit will be described through reference to FIG. 16. Here, the operation involved in mounting the three-dimensional imaging-use interchangeable lens unit 200 to the camera body 100 will be described.

When power to the camera body 100 is turned on in a state in which the interchangeable lens unit 200 has not been mounted (state A shown in FIG. 12A), the camera monitor 120 shows a black screen display (what is called a blackout display), for example. In this state, the state of the lens removal button 159 is detected by the lock pin detector 146a (step S61).

If the interchangeable lens unit 200 has not been mounted to the camera body 100, the lens removal button 159 is not pushed in, so the signal voltage of the first detection line SV1 is at the ground level (the detection result of the lock pin detector 146a is “off”). If the lock pin detector 146a shows “off,” the mounting state of the interchangeable lens unit 200 is state A shown in FIG. 12A or state D shown in FIG. 12D.

Meanwhile, in a state in which the lens removal button 159 is pressed, the signal voltage of the first detection line SV1 is 5 V (the detection result of the lock pin detector 146a is “on”). When the lock pin detector 146a shows “on,” the mounting state of the interchangeable lens unit 200 is the state B shown in FIG. 12B or the state C shown in FIG. 12C.

In step S61, the connection state of the body-side terminal 151 and the lens-side terminal 251 is detected by the contact detector 146b (S62). If the interchangeable lens unit 200 has not been mounted to the camera body 100, the body-side terminal 151 is not in contact with the lens-side terminal 251, so the signal voltage of the second detection line SV2 is 5 V (the detection result of the contact detector 146b is “off”). Since the detection result of the lock pin detector 146a is “off” and the detection result of the contact detector 146b is “off,” the mounting state of the interchangeable lens unit 200 is the state A shown in FIG. 12A, and is a state in which the interchangeable lens unit 200 has been completely removed from the camera body 100.

On the other hand, if the body-side terminal 151 is in contact with the lens-side terminal 251, the signal voltage of the second detection line SV2 is at the ground level (the detection result of the contact detector 146b is “on”). Since the detection result of the lock pin detector 146a is “off” and the detection result of the contact detector 146b is “on,” the mounting state of the interchangeable lens unit 200 is the state D shown in FIG. 12D, and is a state in which the interchangeable lens unit 200 has been completely mounted to the camera body 100.

In step S61, if it is determined whether the mounting state of the interchangeable lens unit 200 is state B or C, the camera controller 140 determines whether or not power is being supplied to the interchangeable lens unit 200 (step S67). If power is currently being supplied to the interchangeable lens unit 200, the supply of power to the interchangeable lens unit 200 is ended (step S68). On the other hand, if power has yet to be sent to the interchangeable lens unit 200, the flow moves to step S69 without the processing of step S68 being performed.

The image display section 126 (display controller 125) confirms the detection result of the contact detector 146b in order to determine whether the mounting state of the interchangeable lens unit 200 is state B or C (step S69). If the detection result of the 146b is “off,” the mounting state of the interchangeable lens unit 200 is state B, so the display state of the camera monitor 120 is confirmed by the image display section 126 (step S70). If a real-time image of the subject is being displayed on the camera monitor 120, the display on the camera monitor 120 is halted by the image display section 126, and a black screen is displayed on the camera monitor 120 (step S71). On the other hand, if a real-time image of the subject is not being displayed on the camera monitor 120, the processing moves to step S61 (step S70). Thus, if the body-side terminal 151 and the lens-side terminal 251 are not in contact during the mounting of the interchangeable lens unit 200, a real-time image of the subject is prevented from being displayed on the camera monitor 120 by the image display section 126.

On the other hand, if the detection result of the contact detector 146b is “on,” the mounting state of the interchangeable lens unit 200 is state C, so the processing moves to step S61 without changing the display state of the camera monitor 120 (step S69).

If the lock pin detector 146a shows “off” in step S61 and the contact detector 146b shows “off” in step S62, the interchangeable lens unit 200 is in a state of having been completely removed from the camera body 100, so the image display section 126 confirms that the live-view display has been halted, so that no live-view is displayed on the camera monitor 120. If a live-view is being displayed, the live-view display is halted by the image display section 126 (S71). In this embodiment, in a state in which the interchangeable lens unit 200 has been completely removed from the camera body 100, the camera monitor 120 has a black screen display, so this black screen display is continued in a state in which the interchangeable lens unit 200 has been completely removed from the camera body 100.

On the other hand, if the lock pin detector 146a shows “off” in step S61 and the contact detector 146b shows “on” in step S62, the mounting state of the interchangeable lens unit 200 is state D, so the mounting of the interchangeable lens unit 200 to the camera body 100 is completed. Here, the image display section 126 confirms whether or not a real-time image of the subject is being displayed in order to confirm whether or not the processing of steps S64 to S66 (operation when mounting of the interchangeable lens unit 200 is completed) has already been carried out (step S63). Whether or not steps S64 to S66 have already been executed may also be determined by other processing. If a live-view display state already exists, the processing moves to step S61. If a real-time image of the subject is not being displayed on the camera monitor 120, steps S64 to S66 are executed. More specifically, the supply of power from the camera body 100 to the interchangeable lens unit 200 is begun (step S64). After the supply of power has started, various kinds of information stored in the interchangeable lens unit 200 are acquired by the identification information acquisition section 142, the characteristic information acquisition section 143, and the state information acquisition section 145, and extraction region correction and decision are carried out (step S65). The processing of step S65 corresponds to steps S2 to S15 in FIG. 13, for example, so it will not be described again in detail. After this, a real-time image is displayed on the camera monitor 120, and the processing moves to step S61 (step S66).

Thus, when the interchangeable lens unit 200 is mounted to the camera body 100, a real-time image of the subject is displayed on the camera monitor 120 after completion of the mounting of the interchangeable lens unit 200 to the camera body 100 (that is, only in state D), and no real-time image of the subject is displayed on the camera monitor 120 while mounting is in progress (that is, in states A to C (other than state D)).

As described above, in the mounting of the interchangeable lens unit 200 to the camera body 100, a black screen display is maintained on the camera monitor 120 while the mounting state of the interchangeable lens unit 200 is in states A to C, but when the mounting state of the interchangeable lens unit 200 switches from state C to state D, the camera monitor 120 switches from a black screen display to a real-time display (live-view display) of the subject.

(4) Operation During Removal of Interchangeable Lens Unit

The flow in FIG. 16 also shows the operation of the camera body 100 during the removal of the interchangeable lens unit 200.

For example, in a state in which the interchangeable lens unit 200 is mounted to the camera body 100, a real-time image of the subject is displayed on the camera monitor 120 as discussed above. In the removal of the interchangeable lens unit 200 from the camera body 100, the lens removal button 159 is pressed and the locking of the lock pin 159a is released. At this point, since the state of the lens removal button 159 is being monitored in step S61, if operation of the lens removal button 159 is detected by the lock pin detector 146a, the camera controller 140 determines whether or not power is being supplied from the camera body 100 to the interchangeable lens unit 200 (step S67). Since power is supplied in a state in which the interchangeable lens unit 200 is mounted to the camera body 100, the supply of power from the camera body 100 to the interchangeable lens unit 200 is halted (step S68). That is, if the lens removal button 159 is pressed in a state in which the interchangeable lens unit 200 is mounted to the camera body 100, the supply of power from the camera body 100 to the interchangeable lens unit 200 is halted.

After the supply of power is halted, the image display section 126 checks the detection result of the contact detector 146b in order to determine whether the mounting state of the interchangeable lens unit 200 is state B or C (step S69). Immediately after the lens removal button 159 is pressed, the body-side terminal 151 is in contact with the lens-side terminal 251, so the detection result of the contact detector 146b is “on.” When the detection result of the contact detector 146b is “on,” the mounting state of the interchangeable lens unit 200 is state C, so the image display section 126 checks the display state of the camera monitor 120 (step S72). If there is a live-view display on the camera monitor 120, the processing moves to step S61 and the live-view display is continued. In state D, in which the interchangeable lens unit 200 is mounted to the camera body 100, there is a live-view display on the camera monitor 120, so the live-view display on the camera monitor 120 here is continued unchanged.

When the user further rotates the interchangeable lens unit 200 with respect to the camera body 100, the body-side terminal 151 eventually comes out of contact with the lens-side terminal 251, and the mounting state of the interchangeable lens unit 200 switches from state C to state B. Consequently, the detection result of the contact detector 146b switches from “on” to “off.” When the detection result of the contact detector 146b is “off,” the image display section 126 checks the display state of the camera monitor 120 (step S70). In state C there is a live-view display, so at the point when the mounting state of the interchangeable lens unit 200 switches from state C to state B, the image display section 126 halts the live-view display on the camera monitor 120, and a black screen is displayed on the camera monitor 120 by the image display section 126 (step S71).

When the user further rotates the interchangeable lens unit 200 with respect to the camera body 100, the bayonet coupling is eventually released completely, and the interchangeable lens unit 200 is completely removed from the camera body 100. At this point the lock pin 159a is no longer pressed by the lens mount 250, so the lens removal button 159 returns to its original state, and the detection result of the lock pin detector 146a switches from “on” to “off.” Accordingly, the halted state of the live-view display is maintained by the image display section 126 (steps S70 and S71).

As described above, in the removal of the interchangeable lens unit 200 from the camera body 100, the live-view display is continued while the mounting state of the interchangeable lens unit 200 is states D to C, but when the mounting state of the interchangeable lens unit 200 switches from state C to state B, the camera monitor 120 switches from live-view display to black screen display.

(5) During Mounting of Interchangeable Lens Unit for Two-Dimensional Imaging

The switching of the display when an interchangeable lens unit for two-dimensional imaging is mounted to the camera body 100 will now be described as a comparative example.

For example, when a two-dimensional imaging interchangeable lens unit is mounted to the camera body 100, a black screen display is continued while the mounting state of the interchangeable lens unit is state A or B, but when the mounting state of the interchangeable lens unit switches from state B to state C, the camera monitor 120 switches from a black screen display to a live-view display.

Unlike with the interchangeable lens unit 200 used for three-dimensional imaging, even if an interchangeable lens unit for two-dimensional imaging is rotated around the optical axis, there is no change in the position of the optical image formed on the CMOS image sensor 110. Accordingly, with an interchangeable lens unit for two-dimensional imaging, even if there is a live-view display in state C, there will be no disturbance of the display image attributable to the mounting state of the interchangeable lens unit.

Also, in the removal of an interchangeable lens unit for two-dimensional imaging from the camera body 100, a live-view display is continued while the mounting state of the interchangeable lens unit is in states D to B, but when the interchangeable lens unit switches from state B to state A, the camera monitor 120 switches from a live-view display to a black screen display.

Unlike with the interchangeable lens unit 200 used for three-dimensional imaging, even if an interchangeable lens unit for two-dimensional imaging is rotated around the optical axis, there is no change in the position of the optical image formed on the CMOS image sensor 110. Accordingly, with an interchangeable lens unit for two-dimensional imaging, even if there is a live-view display in states B and C, there will be no disturbance of the display image attributable to the mounting state of the interchangeable lens unit.

Features of Camera Body

As described above, with this camera body 100, the image display section 126 prevents the real-time display of a captured image based on stereo image data until the mounting of the interchangeable lens unit to the body mount 150 is completed, so a captured image of the subject is not displayed on the camera monitor 120 while the mounting of the interchangeable lens unit 200 is in progress. Therefore, disturbance of the display image attributable to the mounting state of the interchangeable lens unit can be prevented.

For example, the interchangeable lens unit 200 forms on the CMOS image sensor 110 a left-eye optical image QL1 and a right-eye optical image QR1 that are arranged side by side, so if the interchangeable lens unit 200 is rotated from the usage position with respect to the camera body 100, the left-eye optical image QL1 and the right-eye optical image QR1 rotate around the center CO (see FIG. 9) on the camera body CMOS image sensor 110. As a result, the images extracted in the recommended extraction regions AL3 and AR3 end up being completely different images that do not lend themselves well to being a stereo image. Even when just either the left or right image is displayed as a representative image, the optical image ends up deviating from the extraction region, so there ends up being disturbance in the display image attributable to the mounting state of the interchangeable lens unit.

With this camera body 100, however, in the mounting of the interchangeable lens unit 200 to the camera body 100, a black screen display is continued until the mounting state of the interchangeable lens unit 200 switches from state C to state D, and the camera monitor 120 switches from a black screen display to a live-view display at the point when the mounting state of the interchangeable lens unit 200 switches from state C to state D.

Therefore, disturbance of a display image attributable to the mounting state of the interchangeable lens unit can be reduced with this camera body 100.

The live-view display state corresponds, for example, to a first display state in which a captured image is displayed on the basis of stereo image data, and the black screen display state corresponds, for example, to a second display state that is different from the first display state.

The second display state need not be a black screen display state (also called a halted display state), and may be any display state other than a live-view display. For instance, a preset specific image (a warning display, a menu display, etc.) may be displayed, recorded images may be reproduced, or, if the camera monitor 120 and the electronic viewfinder 180 are liquid crystal monitors, the backlight may simply be turned off. It should be noted that the preset specific image is one example of a predetermined image.

### Other Embodiments

The present invention is not limited to the embodiment discussed above, and various modifications and changes are possible without departing from the scope of the invention.

(A) An imaging device and a camera body were described using as an example the digital camera 1 having no mirror box, but compatibility with three-dimensional imaging is also possible with a digital single lens reflex camera having a mirror box. The imaging device may be one that is capable of capturing not only still pictures, but also moving pictures.

(B) An interchangeable lens unit was described using the interchangeable lens unit 200 as an example, but the constitution of the three-dimensional optical system is not limited to that in the above embodiment. As long as imaging can be handled with a single imaging element, the three-dimensional optical system may have some other constitution.

(C) The three-dimensional optical system G is not limited to a side-by-side imaging system, and a time-division imaging system may instead be employed as the optical system for the interchangeable lens unit, for example. Also, in the above embodiment, an ordinary side-by-side imaging system was used as an example, but a horizontal compression side-by-side imaging system in which left- and right-eye images are compressed horizontally, or a rotated side-by-side imaging system in which left- and right-eye images are rotated 90 degrees may be employed.

(D) In the embodiment above, the lens removal button 159 is also pushed in when the lock pin 159a is pushed in, but a constitution may be employed in which the lens removal button 159 is not pushed in even though the lock pin 159a is pushed in. In this case, the lock pin 159a is constituted by a member that is separate from the lens removal button 159, but what is the same is that the lock pin 159a is also pushed in when the lens removal button 159 is pressed.

(E) The above-mentioned interchangeable lens unit 200 may be a single focus lens. In this case, the extraction centers ACL2 and ACR2 can be found by using the above-mentioned extraction position correction amount L11. Furthermore, if the interchangeable lens unit 200 is a single focus lens, then zoom lenses 210L and 210R may be fixed, for example, and this eliminates the need for a zoom ring 213 and zoom motors 214L and 214R.

(F) In the above embodiment, when the lens removal button 159 is pressed in a state in which the interchangeable lens unit 200 is mounted to the camera body 100, the supply of power from the camera body 100 to the interchangeable lens unit 200 is halted, but the supply of power may instead be halted at the point when the detection result of the contact detector 146b shows “off.”

(G) The various flows are not limited to those discussed above. To the extent that the desired effect is obtained, the flow order and so forth may be changed.

(H) In the above embodiment, the mounting state of the interchangeable lens unit 200 is determined on the basis of the detection results of the lock pin detector 146a and the contact detector 146b, but how the mounting state of the interchangeable lens unit 200 is determined is not limited to the above embodiment. For instance, a separate sensor may be provided that can detect that the mounting of the interchangeable lens unit 200 to the camera body 100 has been completed.

### General Interpretation of Terms

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts.

The term “configured” as used herein to describe a component, section or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A camera body comprising:
a body mount configured o support an interchangeable lens unit, the interchangeable lens unit being configured to form left-eye and right-eye optical images of a subject;
an image production section configured to produce stereo image data based the left-eye and right-eye optical images; and
an image display section configured to display a captured image based on the stereo image data, the image display section being configured to restrict real-time display of the captured image until the interchangeable lens unit is coupled to the body mount.

2. The camera body according to claim 1, wherein
the image display section is configured to switch between a first display state and a second display state different from the first display state, and
the captured image is displayed in real time based on the stereo image data in the first display state.

3. The camera body according to claim 2, wherein
the image display section is operational in the second display state until the interchangeable lens unit is coupled to the body mount, once the interchangeable lens unit is coupled to the body mount, the image display section is configured to switch from the second display state to the first display state.

4. The camera body according to claim 3, wherein
the second display state includes a situation where display of the subject is terminated and/or a situation where a predetermined image is displayed.

5. The camera body according to claims 2, wherein
the image display section switches from the first display state to the second display state upon removal of the interchangeable lens unit from the body mount.

6. The camera body according to claim 2, further comprising:
a mounting detector configured to detect the mounting state of the interchangeable lens unit with respect to the body mount, wherein
the image display section is configured to switch between the first and second display states based on the results of the mounting detector.

7. The camera body according to claim 6, further comprising:
an electrical contact provided in the body mount and arranged to be electrically connected to the interchangeable lens unit, wherein
the mounting detector includes a first and a second detector configured to detect the mounting state of the interchangeable lens unit with respect to the body mount, the first detector being configured to detect whether the interchangeable lens unit is attached to or removed from the body mount, and the second detector being configured to detect whether the interchangeable lens unit is electrically connected to the electrical contact.

8. The camera body according to claim 7, wherein
when the first detector detects that the interchangeable lens unit is not being attached to or not being removed from the body mount and the second detector detects that the interchangeable lens unit is electrically connected to the electrical contact, the image display section starts displaying the captured image in real-time based on the stereo image data.

9. The camera body according to claim 8, wherein
when the first detector detects that the interchangeable lens unit is being attached to or being removed from the body mount and the second detector detects that the interchangeable lens unit is not electrically connected to the electrical contact, the image display section stops displaying the captured image in the real-time based on the stereo image data.

10. An imaging device comprising:
an interchangeable lens unit configured to form left-eye and right-eye optical images of a subject; and
the camera body according to claim 1.

11. A method for controlling a camera body configured to support an interchangeable lens unit that is configured to form left-eye and right-eye optical images of a subject, the method comprising:
detecting the mounting state of the interchangeable lens unit with respect to the camera body; and
restricting real-time display of a captured image based on stereo image data of the left-eye and right-eye optical images on a display section until the interchangeable lens unit is coupled to the camera body.

12. A program configured to cause a camera body to execute the processes of:
detecting the mounting state of an interchangeable lens unit to the camera body, the interchangeable lens unit being configured to form left-eye and right-eye optical images of a subject; and
restricting real-time display of a captured image based on stereo image data of the left-eye and right-eye optical images on a display section until the interchangeable lens unit is coupled to the camera body.

13. A computer-readable storage medium having a computer-readable program stored thereon, the computer-readable storage medium being coupled to a camera body to cause the camera body to perform the processes of:
detecting the mounting state of an interchangeable lens unit to the camera body, the interchangeable lens unit being configured to form left-eye and right-eye optical images of a subject; and
restricting real-time display of a captured image based on stereo image data of the left-eye and right-eye optical images on a display section until the interchangeable lens unit is coupled to the camera body.
